(19) United States
(12) Patent Application Publication
(10) Pub. No.: US 2018/0163901 A1
(43) Pub. Date: Jun. 14, 2018

(54) HOSES, COMPOSITIONS, AND METHODS OF MAKING THE SAME

(71) Applicant: Cooper-Standard Automotive Inc., Novi, MI (US)

(72) Inventors: Krishnamachari Gopalan, Troy, MI (US); Robert J. Lenhart, Fort Wayne, IN (US); Gending Ji, Waterloo, Ontario (CA); Roland Herd-Smith, Brignancourt (FR)

(73) Assignee: Cooper-Standard Automotive Inc., Novi, MI (US)

(21) Appl. No.: 15/836,387

(22) Filed: Dec. 8, 2017

Related U.S. Application Data
(60) Provisional application No. 62/497,959, filed on Dec. 10, 2016.

(51) Int. Cl. F16L 11/08; C08L 23/06; C08L 23/12; C08K 3/013; C08K 5/00; C08F 255/02; C08J 3/24

(52) U.S. Cl. CPC F16L 11/08; C08L 23/06; C08L 23/12; C08K 3/013; C08K 5/0025; C08J 2423/06; C08J 3/24; C08L 2205/02; C08L 2312/08; C08L 2666/72; C08J 2423/12; C08F 255/02

(57) ABSTRACT

A hose is provided. The hose has a composition including a silane-crosslinked polyolefin elastomer and a filler. The hose composition exhibits a compression set of from about 5% to about 35%, as measured according to ASTM D 395 Method B (168 hrs at 150 ° C.). The hose composition additionally has a density from about 0.88 g/cm³ to about 1.05 g/cm³. The hose may be used for transferring coolant liquid in a motor of a vehicle and includes a first outer layer of a first silane-crosslinked polyolefin elastomer; a second inner layer of a second silane-crosslinked polyolefin elastomer; and a textile reinforcement layer embedded between the first and second layers of the silane-crosslinked polyolefin elastomers.

### CROSS-REFERENCE TO RELATED APPLICATION

This application claims priority under 35 U.S.C. 119(e) to U.S. Provisional Patent Application No. 62/497,959, filed Dec. 10, 2016, entitled “HOSE, COMPOSITION INCLUDING SILANE-GRAFTED POLYOLEFIN, AND PROCESS OF MAKING A HOSE,” which is herein incorporated by reference in its entirety.

### FIELD OF THE DISCLOSURE

The present disclosure relates to silane-crosslinked polyolefin elastomer compositions used to fabricate hoses that may be used in vehicles and methods for forming the silane-crosslinked polyolefin elastomer compositions and/or hoses.

### BACKGROUND OF THE DISCLOSURE

Rubber or elastomer hoses used in automotive applications must be capable of transferring fluid while exhibiting no dimensional change or leakage, low reaction forces to interfaces (e.g., minimize vibrations), and good pressure and heat resistance.

Currently, the hoses used to circulate coolant liquid in vehicles, for example, are made with ethylene propylene diene monomer (EPDM) rubber with a fabric or textile (e.g., yarn, KEVLAR, nylon, or polyester) incorporated for structural reinforcement. EPDM rubber formulations used in hose applications typically require many ingredients (e.g., carbon black, petroleum-based oil, zinc oxide, miscellaneous fillers such as calcium carbonate or talc, processing aids, curatives, blowing agents, and many other materials to meet performance requirements) all of which can raise the EPDM rubber's density (e.g., from 1.10 to 1.40 g/cm³).

In order to help reduce CO₂ emissions, vehicle manufacturers are mindful of the need to decrease the weight of the vehicles. Reducing the weight of hoses can contribute to this goal. Thus, it would be desirable to develop new polymer compositions used to manufacture hoses that are easier to produce and are lighter in weight.

### SUMMARY OF THE DISCLOSURE

According to one aspect of the present disclosure, a hose is provided. The hose has a composition including a silane-crosslinked polyolefin elastomer and a filler. The hose composition exhibits a compression set of from about 5% to about 35%, as measured according to ASTM D 395 Method B (168 hrs at 150° C.). The hose composition additionally has a density from about 0.88 g/cm³ to about 1.05 g/cm³.

According to another aspect of the present disclosure, a hose for transferring coolant liquid in a motor of a vehicle is provided. The hose includes a first layer of a first silane-crosslinked polyolefin elastomer; a second layer of a second silane-crosslinked polyolefin elastomer; and a textile reinforcement embedded between the first and second layers of the silane-crosslinked polyolefin elastomers.

According to still another aspect of the present disclosure, a method for making a hose is provided. The method includes: extruding a first polyolefin having a density less than 0.86 g/cm³, a second polyolefin, a silane crosslinker, a radical initiator, and a condensation catalyst together to form an extruded crosslinkable polyolefin blend; cooling the extruded crosslinkable polyolefin blend; forming the extruded crosslinkable polyolefin blend into a hose element; and crosslinking the blend of the hose element to form the hose. The hose exhibits a compression set of from about 5% to about 35%, as measured according to ASTM D 395 Method B (168 hrs at 150° C.). In addition, the hose has a density from about 0.88 g/cm³ to about 1.05 g/cm³.

These and other aspects, objects, and features of the present invention will be understood and appreciated by those skilled in the art upon studying the following specification, claims, and appended drawings.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front isometric view of two hoses having a knitted reinforcement layer according to some aspects of the present disclosure;

FIG. 2 is a schematic cross-sectional view of two hoses having a braided and spiral reinforcement layer according to some aspects of the present disclosure;

FIG. 3 is a side view of a portion of a hose formed with a silane-crosslinked polyolefin elastomer of the present disclosure;

FIG. 4 is a perspective view of another exemplary hose in accordance with some aspects of the present disclosure;

FIG. 5 is a schematic reaction pathway used to produce a silane-crosslinked polyolefin elastomer according to some aspects of the present disclosure;

FIG. 6A is a schematic cross-sectional view of a reactive twin-screw extruder according to some aspects of the present disclosure;

FIG. 6B is a schematic cross-sectional view of a reactive single-screw extruder according to some aspects of the present disclosure;

FIG. 7 is a schematic cross-sectional view of a reactive single-screw extruder according to some aspects of the present disclosure;

FIG. 8 is a flow diagram of a method for making a hose in accordance with some aspects of the present disclosure;

FIG. 9 are schematic isometric views of the feed end (900A), mid-section (900B), and tip (900C) of an exemplary extruder screw in accordance with some aspects of the present disclosure; and

FIG. 10 is a relaxation plot of an exemplary silane-crosslinked polyolefin elastomer, suitable for a hose according to aspects of the disclosure, and comparative EPDM cross-linked materials.

### DETAILED DESCRIPTION OF THE PREFERRED EMBODIMENTS

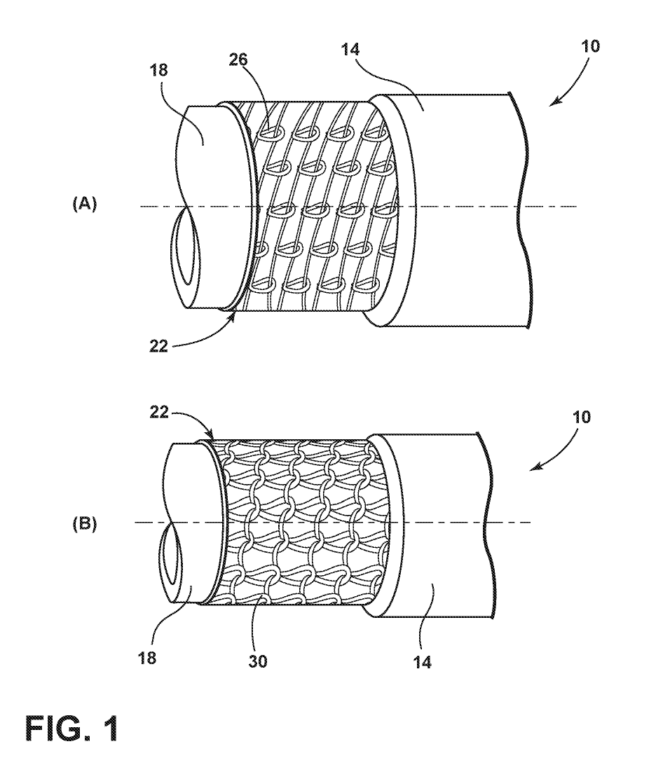

For purposes of description herein the terms “upper,” “lower,” “right,” “left,” “rear,” “front,” “vertical,” “horizontal,” and derivatives thereof shall relate to the hoses of the disclosure as shown in FIG. 1. However, it is to be understood that the hoses and methods of making them may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

A value modified by a term or terms, such as “about” and “substantially,” may not be limited to the precise value specified. The approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.”

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Referring to FIGS. 1-4, a hose 10 is provided. The hose 10 has a composition including a silane-crosslinked polyolefin elastomer and a filler. The hose 10 composition exhibits a compression set of from about 5% to about 35%, as measured according to ASTM D 395 Method B (168 hrs at 150° C.). The hose composition additionally has a density from about 0.88 g/cm³ to about 1.05 g/cm³. The hose 10 may be used for transferring coolant liquid in a motor of a vehicle and includes an outer layer 14 of a first silane-crosslinked polyolefin elastomer; an inner layer 18 of a second silane-crosslinked polyolefin elastomer; and a textile reinforcement layer 22 embedded between the first and second layers 14, 18 of the first and second silane-crosslinked polyolefin elastomers.

Referring now to FIG. 1, the hose 10 includes the textile reinforcement layer 22 embedded between the outer layer 14 and the inner layer 18. The textile reinforcement layer 22 may be made from a variety of different naturally occurring textiles, synthetic materials, fabrics, threading, fibers, and combinations thereof. The hose 10 may have a pressure resistance of at least 10 bars at 150° C., at least 7 bars at 150° C., at least 5 bars at 150° C., at least 3 bars at 150° C., or at least 2 bars at 150° C. depending on the type of silane-crosslinked polyolefin elastomer and/or textile reinforcement layer 22 used to make the hose 10. In some aspects, the yarn used to make the textile reinforcement layer 22 may include a knitted fabric, a braided fabric, or spiral fabric. FIG. 1(A) illustrates knitted fabric where the knit can include a knitted lock stitch 26 and FIG. 1(B) illustrates a knit having a knitted plain stitch 30.

In some aspects, the textile used for the textile reinforcement layer 22 may include a synthetic material including a polyaramid, KEVLAR™, TWARON™, a polyamide, a polyester, RAYON™, NOMEX™, TECHNORA™, or a combination thereof. In some aspects, the textile used to make the textile reinforcement layer 22 may include a combination of aramid, polyamide, and/or polyester. In some aspects, the textile reinforcement layer 22 is a yarn that is knitted, braided, and/or spirally weaved. In some aspects, the yarn may be replaced by short fibers mixed with the silane-grafted polyolefin elastomer for added structural reinforcement. In other aspects, the textile reinforcement layer 22 may be a reinforcement layer that does not use a textile. For example, the reinforcement layer may utilize glass fibers, carbon nanotube sheets, carbon nanotube fibers, or other materials or carbon allotropes known and used in the art for strengthening purposes. It will be appreciated by one having ordinary skill in the art that other suitable reinforcement materials may be used without departing from the scope and intent of the present disclosure.

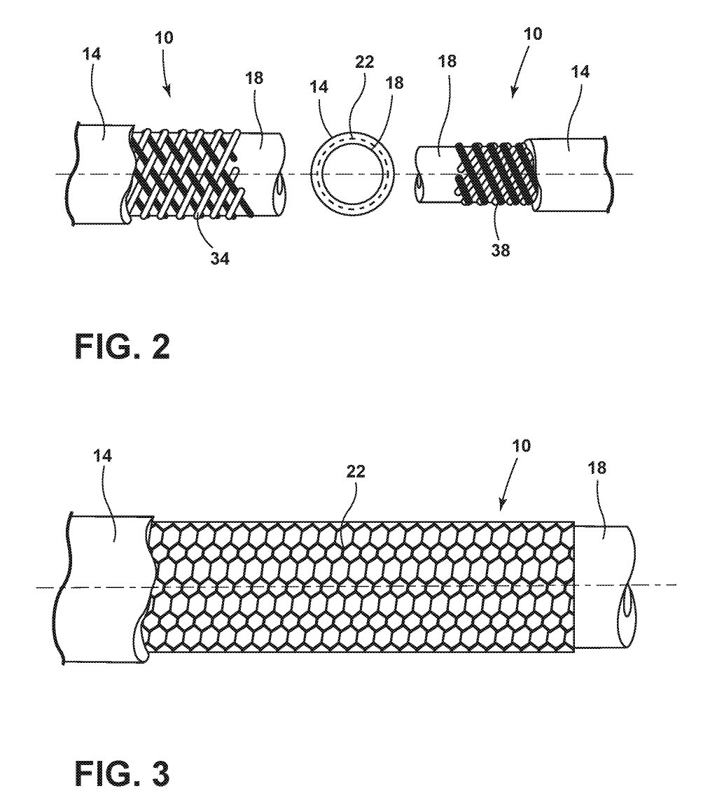

FIG. 2 illustrates a braided fabric 34 (left) and a spiral fabric 38 (right) used to make the textile reinforcement layer 22 embedded between the outer layer 14 and the inner layer 18 of the first and second silane-crosslinked polyolefin elastomers of the hose 10. The cross-sectional view of the hose 10 (i.e., in the central portion of FIG. 2) displays the textile reinforcement layer 22 embedded between the outer and inner layers 14, 18 where the two layers 14, 18 have approximately the same thickness. In some aspects, the thickness of the outer layer 14 may be greater than the thickness of the inner layer 18. In other aspects, the thickness of the outer layer 14 may be less than the thickness of the inner layer 18.

Referring now to FIG. 3, a side view of a portion of the hose 10 formed with the silane-crosslinked polyolefin elastomers are provided. In some aspects, as provided in FIG. 3, the outline of the textile reinforcement layer 22 positioned or extruded between the outer layer 14 and the inner layer 18 may be visible to the naked eye. The hose 10 may be formed/extruded using a variety of different fillers including color agents. In some aspects, the hose 10 may be transparent and in other aspects the hose 10 may be colored.

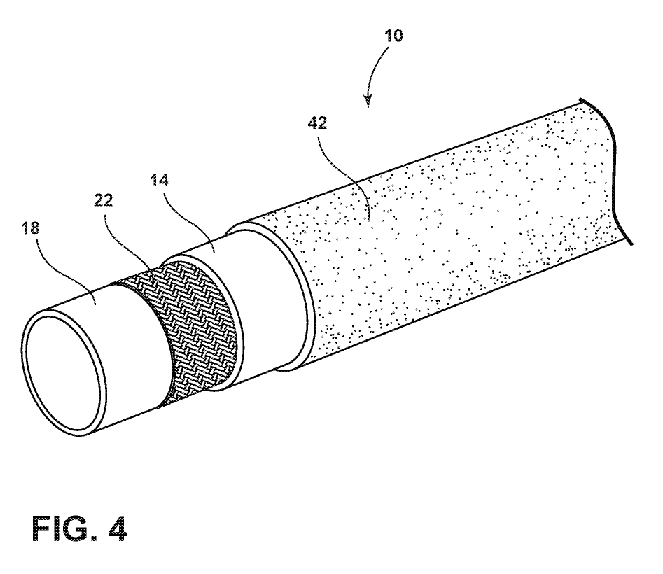

Referring now to FIG. 4, a perspective view of the hose 10 is provided, according to some aspects of the present disclosure. The hose 10 depicted in FIG. 4 includes, in sequence going from the center out, the inner layer 18, the textile reinforcement layer 22, the outer layer 14, and an abrasion resistant second outer layer 42. As disclosed herein, the inner layer 18 and/or the outer layer 14 may include or be fabricated from the silane-crosslinked polyolefin elastomers disclosed herein. In some aspects, the abrasion resistant second outer layer 42 may additionally be made or fabricated from these silane-crosslinked polyolefin elastomers. In some aspects, the hose 10 may include two or more inner and/or outer layers comparable in construction and composition to the inner and outer layers 18, 14.

In some aspects, the wall thickness of the hose 10, may be from about 1 to about 10 mm, from about 1 to about 4 mm, or from about 1.5 to about 2.5 mm. The wall thickness of the hose 10 is equal to the sum of the thicknesses of all of the individual layers of the hose 10 including, for example, the thickness of inner layer 18, the thickness of the textile reinforcement layer 22, and the thickness of the outer layer 14. In other aspects, the wall thickness may include additional layers including, for example, the abrasion resistant second outer layer 42. The hoses 10 of the present disclosure may exhibit a reduced weight relative to conventional hoses, for example, EPDM, TPV, PVC, and PUR hoses. In some aspects, the weight of the hose 10 may be reduced by about 30%, about 40%, about 50%, about 60%, or about 70% due to the reductions in specific gravity of the silane-crosslinked polyolefin elastomers of the disclosure and/or the wall thickness of the hose 10 associated with these elastomers.

The disclosure focuses on the composition, method of making the composition, and the corresponding material properties for the silane-crosslinked polyolefin elastomer blends used to make hoses 10. The hose 10 is formed from a silane-grafted polyolefin or silane-grafted polyolefin elastomer where the silane-grafted polyolefin may have a condensation catalyst added to form a silane-crosslinkable polyolefin elastomer. This silane-crosslinkable polyolefin elastomer may then be crosslinked upon exposure to moisture and/or heat to form the final silane-crosslinked polyolefin elastomer or blend. In aspects, the silane-crosslinked polyolefin elastomer or blend includes a first polyolefin having a density less than 0.90 g/cm³, a second polyolefin having a crystallinity of less than 60%, a silane crosslinker, a graft initiator, and a condensation catalyst.

### First Polyolefin

The first polyolefin can be a polyolefin elastomer including an olefin block copolymer, an ethylene/α-olefin copolymer, a propylene/α-olefin copolymer, EPDM, EPM, or a mixture of two or more of any of these materials. Exemplary block copolymers include those sold under the trade names INFUSE™, an olefin block co-polymer (the Dow Chemical Company) and SEPTON™ V-SERIES, a styrene-ethylene-butylene-styrene block copolymer (Kuraray Co., LTD.). Exemplary ethylene/α-olefin copolymers include those sold under the trade names TAFMER™ (e.g., TAFMER DF710) (Mitsui Chemicals, Inc.), and ENGAGE™ (e.g., ENGAGE 8150) (the Dow Chemical Company). Exemplary propylene/α-olefin copolymers include those sold under the trade name VISTAMAXX™ 6102 grades (Exxon Mobil Chemical Company), TAFMER™ XM (Mitsui Chemical Company), and VERSIFY™ (Dow Chemical Company). The EPDM may have a diene content of from about 0.5 to about 10 wt %. The EPM may have an ethylene content of 45 wt % to 75 wt %.

The term “comonomer” refers to olefin comonomers which are suitable for being polymerized with olefin monomers, such as ethylene or propylene monomers. Comonomers may comprise but are not limited to aliphatic C₂-C₂₀ α-olefins. Examples of suitable aliphatic C₂-C₂₀ α-olefins include ethylene, propylene, 1-butene, 4-methyl-1-pentene, 1-hexene, 1-octene, 1-decene, 1-dodecene, 1-tetradecene, 1-hexadecene, 1-octadecene and 1-eicosene. In an embodiment, the comonomer is vinyl acetate. The term “copolymer” refers to a polymer, which is made by linking more than one type of monomer in the same polymer chain. The term “homopolymer” refers to a polymer which is made by linking olefin monomers, in the absence of comonomers. The amount of comonomer can, in some embodiments, be from greater than 0 wt % to about 12 wt % based on the weight of the polyolefin, including from greater than 0 wt % to about 9 wt %, and from greater than 0 wt % to about 7 wt %. In some embodiments, the comonomer content is greater than about 2 mol % of the final polymer, including greater than about 3 mol % and greater than about 6 mol %. The comonomer content may be less than or equal to about 30 mol %. A copolymer can be a random or block (heterophasic) copolymer. In some embodiments, the polyolefin is a random copolymer of propylene and ethylene.

In some aspects, the first polyolefin is selected from the group consisting of: an olefin homopolymer, a blend of homopolymers, a copolymer made using two or more olefins, a blend of copolymers each made using two or more olefins, and a combination of olefin homopolymers blended with copolymers made using two or more olefins. The olefin may be selected from ethylene, propylene, 1-butene, 1-propene, 1-hexene, 1-octene, and other higher 1-olefin. The first polyolefin may be synthesized using many different processes (e.g., using gas phase and solution based metallocene catalysis and Ziegler-Natta catalysis) and optionally using a catalyst suitable for polymerizing ethylene and/or α-olefins. In some aspects, a metallocene catalyst may be used to produce low density ethylene/α-olefin polymers.

In some aspects, the polyethylene used for the first polyolefin can be classified into several types including, but not limited to, LDPE (Low Density Polyethylene), LLDPE (Linear Low Density Polyethylene), and HDPE (High Density Polyethylene). In other aspects, the polyethylene can be classified as Ultra High Molecular Weight (UHMW), High Molecular Weight (HMW), Medium Molecular Weight (MMW) and Low Molecular Weight (LMW). In still other aspects, the polyethylene may be an ultra-low density ethylene elastomer.

In some aspects, the first polyolefin may include a LDPE/silane copolymer or blend. In other aspects, the first polyolefin may be polyethylene that can be produced using any catalyst known in the art including, but not limited to, chromium catalysts, Ziegler-Natta catalysts, metallocene catalysts or post-metallocene catalysts.

In some aspects, the first polyolefin may have a molecular weight distribution M_{w}/Mₙ of less than or equal to about 5, less than or equal to about 4, from about 1 to about 3.5, or from about 1 to about 3.

The first polyolefin may be present in an amount of from greater than 0 to about 100 wt % of the composition. In some embodiments, the amount of polyolefin elastomer is from about 30 to about 70 wt %. In some aspects, the first polyolefin fed to an extruder can include from about 50 wt % to about 80 wt % of an ethylene/α-olefin copolymer, including from about 60 wt % to about 75 wt %, and from about 62 wt % to about 72 wt %.

The first polyolefin may have a melt viscosity in the range of from about 2,000 cP to about 50,000 cP as measured using a Brookfield viscometer at a temperature of about 177° C. In some embodiments, the melt viscosity is from about 4,000 cP to about 40,000 cP, including from about 5,000 cP to about 30,000 cP and from about 6,000 cP to about 18,000 cP.

The first polyolefin may have a melt index (T2), measured at 190° C. under a 2.16 kg load, of from about 20.0 g/10 min to about 3,500 g/10 min, including from about 250 g/10 min to about 1,900 g/10 min and from about 300 g/10 min to about 1,500 g/10 min. In some aspects, the first polyolefin has a fractional melt index of from 0.5 g/10 min to about 3,500 g/10 min.

In some aspects, the density of the first polyolefin is less than 0.90 g/cm³, less than about 0.89 g/cm³, less than about 0.88 g/cm³, less than about 0.87 g/cm³, less than about 0.86 g/cm³, less than about 0.85 g/cm³, less than about 0.84 g/cm³, less than about 0.83 g/cm³, less than about 0.82 g/cm³, less than about 0.81 g/cm³, or less than about 0.80 g/cm³. In other aspects, the density of the first polyolefin may be from about 0.85 g/cm³to about 0.89 g/cm³, from about 0.85 g/cm³to about 0.88 g/cm³, from about 0.84 g/cm³to about 0.88 g/cm³, or from about 0.83 g/cm³to about 0.87 g/cm³. In still other aspects, the density is at about 0.84 g/cm³, about 0.85 g/cm³, about 0.86 g/cm³, about 0.87 g/cm³, about 0.88 g/cm³, or about 0.89 g/cm³.

The percent crystallinity of the first polyolefin may be less than about 60%, less than about 50%, less than about 40%, less than about 35%, less than about 30%, less than about 25%, or less than about 20%. The percent crystallinity may be at least about 10%. In some aspects, the crystallinity is in the range of from about 2% to about 60%.

### Second Polyolefin

The second polyolefin can be a polyolefin elastomer including an olefin block copolymer, an ethylene/α-olefin copolymer, a propylene/α-olefin copolymer, EPDM, EPM, or a mixture of two or more of any of these materials. Exemplary block copolymers include those sold under the trade names INFUSE™ (the Dow Chemical Company) and SEPTON™ V-SERIES (Kuraray Co., LTD.). Exemplary ethylene/α-olefin copolymers include those sold under the trade names TAFMER™ (e.g., TAFMER DF710) (Mitsui Chemicals, Inc.) and ENGAGE™ (e.g., ENGAGE 8150) (the Dow Chemical Company). Exemplary propylene/α-olefin copolymers include those sold under the trade name TAFMER™ XM grades (Mitsui Chemical Company) and VISTAMAXX™ (e.g., VISTAMAXX 6102) (Exxon Mobil Chemical Company). The EPDM may have a diene content of from about 0.5 to about 10 wt %. The EPM may have an ethylene content of 45 wt % to 75 wt %.

In some aspects, the second polyolefin is selected from the group consisting of: an olefin homopolymer, a blend of homopolymers, a copolymer made using two or more olefins, a blend of copolymers each made using two or more olefins, and a blend of olefin homopolymers with copolymers made using two or more olefins. The olefin may be selected from ethylene, propylene, 1-butene, 1-propene, 1-hexene, 1-octene, and other higher 1-olefin. The first polyolefin may be synthesized using many different processes (e.g., using gas phase and solution based metallocene catalysis and Ziegler-Natta catalysis) and optionally using a catalyst suitable for polymerizing ethylene and/or α-olefins. In some aspects, a metallocene catalyst may be used to produce low density ethylene/α-olefin polymers.

In some aspects, the second polyolefin may include a polypropylene homopolymer, a polypropylene copolymer, a polyethylene-co-propylene copolymer, or a mixture thereof. Suitable polypropylenes include but are not limited to polypropylene obtained by homopolymerization of propylene or copolymerization of propylene and an α-olefin comonomer. In some aspects, the second polyolefin may have a higher molecular weight and/or a higher density than the first polyolefin.

In some embodiments, the second polyolefin may have a molecular weight distribution M_{w}/Mₙ of less than or equal to about 5, less than or equal to about 4, from about 1 to about 3.5, or from about 1 to about 3.

The second polyolefin may be present in an amount of from greater than 0 wt % to about 100 wt % of the composition. In some embodiments, the amount of polyolefin elastomer is from about 30 wt % to about 70 wt %. In some embodiments, the second polyolefin fed to the extruder can include from about 10 wt % to about 50 wt % polypropylene, from about 20\ wt % to about 40 wt % polypropylene, or from about 25 wt % to about 35 wt % polypropylene. The polypropylene may be a homopolymer or a copolymer.

The second polyolefin may have a melt viscosity in the range of from about 2,000 cP to about 50,000 cP as measured using a Brookfield viscometer at a temperature of about 177° C. In some embodiments, the melt viscosity is from about 4,000 cP to about 40,000 cP, including from about 5,000 cP to about 30,000 cP and from about 6,000 cP to about 18,000 cP.

The second polyolefin may have a melt index (T2), measured at 190° C. under a 2.16 kg load, of from about 20.0 g/10 min to about 3,500 g/10 min, including from about 250 g/10 min to about 1,900 g/10 min and from about 300 g/10 min to about 1,500 g/10 min. In some embodiments, the polyolefin has a fractional melt index of from 0.5 g/10 min to about 3,500 g/10 min.

In some aspects, the density of the second polyolefin is less than 0.90 g/cm³, less than about 0.89 g/cm³, less than about 0.88 g/cm³, less than about 0.87 g/cm³, less than about 0.86 g/cm³, less than about 0.85 g/cm³, less than about 0.84 g/cm³, less than about 0.83 g/cm³, less than about 0.82 g/cm³, less than about 0.81 g/cm³, or less than about 0.80 g/cm³. In other aspects, the density of the first polyolefin may be from about 0.85 g/cm³to about 0.89 g/cm³, from about 0.85 g/cm³to about 0.88 g/cm³, from about 0.84 g/cm³to about 0.88 g/cm³, or from about 0.83 g/cm³to about 0.87 g/cm³. In still other aspects, the density is at about 0.84 g/cm³, about 0.85 g/cm³, about 0.86 g/cm³, about 0.87 g/cm³, about 0.88 g/cm³, or about 0.89 g/cm³.

The percent crystallinity of the second polyolefin may be less than about 60%, less than about 50%, less than about 40%, less than about 35%, less than about 30%, less than about 25%, or less than about 20%. The percent crystallinity may be at least about 10%. In some aspects, the crystallinity is in the range of from about 2% to about 60%.

As noted, the silane-crosslinked polyolefin elastomer or blend, e.g., as employed in the hose 10, includes both the first polyolefin and the second polyolefin. The second polyolefin is generally used to modify the hardness and/or processability of the first polyolefin having a density less than 0.90 g/cm³. In some aspects, more than just the first and second polyolefins may be used to form the silane-crosslinked polyolefin elastomer or blend. For example, in some aspects, one, two, three, four, or more different polyolefins having a density less than 0.90 g/cm³, less than 0.89 g/cm³, less than 0.88 g/cm³, less than 0.87 g/cm³, less than 0.86 g/cm³, or less than 0.85 g/cm³ may be substituted and/or used for the first polyolefin. In some aspects, one, two, three, four, or more different polyolefins, polyethylene-co-propylene copolymers may be substituted and/or used for the second polyolefin.

The blend of the first polyolefin having a density less than 0.90 g/cm³ and the second polyolefin having a crystallinity less than 40% is used because the subsequent silane grafting and crosslinking of these first and second polyolefin materials together are what form the core resin structure in the final silane-crosslinked polyolefin elastomer. Although additional polyolefins may be added to the blend of the silane-grafted, silane-crosslinkable, and/or silane-crosslinked polyolefin elastomer as fillers to improve and/or modify the Young's modulus as desired for the final product, any polyolefins added to the blend having a crystallinity equal to or greater than 40% are not chemically or covalently incorporated into the crosslinked structure of the final silane-crosslinked polyolefin elastomer.

In some aspects, the first and second polyolefins may further include one or more TPVs and/or EPDM with or without silane graft moieties where the TPV and/or EPDM polymers are present in an amount of up to 20 wt % of the silane-crosslinker polyolefin elastomer/blend.

### Grafting Initiator

A grafting initiator (also referred to as “a radical initiator” in the disclosure) can be utilized in the grafting process of at least the first and second polyolefins by reacting with the respective polyolefins to form a reactive species that can react and/or couple with the silane crosslinker molecule. The grafting initiator can include halogen molecules, azo compounds (e.g., azobisisobutyl), carboxylic peroxyacids, peroxyesters, peroxyketals, and peroxides (e.g., alkyl hydroperoxides, dialkyl peroxides, and diacyl peroxides). In some embodiments, the grafting initiator is an organic peroxide selected from di-t-butyl peroxide, t-butyl cumyl peroxide, dicumyl peroxide, 2,5-dimethyl-2,5-di(t-butyl-peroxy)hexyne-3, 1,3-bis(t-butyl-peroxy-isopropyl)benzene, n-butyl-4,4-bis(t-butyl-peroxy)valerate, benzoyl peroxide, t-butylperoxybenzoate, t-butylperoxy isopropyl carbonate, and t-butylperbenzoate, as well as bis(2-methylbenzoyl)peroxide, bis(4-methylbenzoyl)peroxide, t-butyl peroctoate, cumene hydroperoxide, methyl ethyl ketone peroxide, lauryl peroxide, tert-butyl peracetate, di-t-amyl peroxide, t-amyl peroxybenzoate, 1,1-bis(t-butylperoxy)-3,3,5-trimethylcyclohexane, α,α′-bis(t-butylperoxy)-1,3-diisopropylbenzene, α,α′-bis(t-butylpexoxy)-1,4-diisopropylbenzene, 2,5-bis(t-butylperoxy)-2,5-dimethylhexane, and 2,5-bis(t-butylperoxy)-2,5-dimethyl-3-hexyne and 2,4-dichlorobenzoyl peroxide. Exemplary peroxides include those sold under the tradename LUPEROX™ (available from Arkema, Inc.).

In some aspects, the grafting initiator is present in an amount of from greater than 0 wt % to about 2 wt % of the composition, including from about 0.15 wt % to about 1.2 wt % of the composition. The amount of initiator and silane employed may affect the final structure of the silane grafted polymer (e.g., the degree of grafting in the grafted polymer and the degree of crosslinking in the cured polymer). In some aspects, the reactive composition contains at least 100 ppm of initiator, or at least 300 ppm of initiator. The initiator may be present in an amount from 300 ppm to 1500 ppm or from 300 ppm to 2000 ppm. The silane:initiator weight ratio may be from about 20:1 to 400:1, including from about 30:1 to about 400:1, from about 48:1 to about 350:1, and from about 55:1 to about 333:1.

The grafting reaction can be performed under conditions that optimize grafts onto the interpolymer backbone while minimizing side reactions (e.g., the homopolymerization of the grafting agent). The grafting reaction may be performed in a melt, in solution, in a solid-state, and/or in a swollen-state. The silanation may be performed in a wide-variety of equipment (e.g., twin screw extruders, single screw extruders, Brabenders, internal mixers such as Banbury mixers, and batch reactors). In some embodiments, the polyolefin, silane, and initiator are mixed in the first stage of an extruder. The melt temperature (i.e., the temperature at which the polymer starts melting and starts to flow) may be from about 120° C. to about 260° C., including from about 130° C. to about 250° C.

### Silane Crosslinker

A silane crosslinker can be used to covalently graft silane moieties onto the first and second polyolefins and the silane crosslinker may include alkoxysilanes, silazanes, siloxanes, or a combination thereof. The grafting and/or coupling of the various potential silane crosslinkers or silane crosslinker molecules is facilitated by the reactive species formed by the grafting initiator reacting with the respective silane crosslinker.

In some aspects, the silane crosslinker is a silazane where the silazane may include, for example, hexamethyldisilazane (HMDS) or Bis(trimethylsilyl)amine. In some aspects, the silane crosslinker is a siloxane where the siloxane may include, for example, polydimethylsiloxane (PDMS) and octamethylcyclotetrasiloxane.

In some aspects, the silane crosslinker is an alkoxysilane. As used herein, the term “alkoxysilane” refers to a compound that comprises a silicon atom, at least one alkoxy group and at least one other organic group, wherein the silicon atom is bonded with the organic group by a covalent bond. Preferably, the alkoxysilane is selected from alkylsilanes; acryl-based silanes; vinyl-based silanes; aromatic silanes; epoxy-based silanes; amino-based silanes and amines that possess —NH₂, —NHCH₃or —N(CH₃)₂; ureide-based silanes; mercapto-based silanes; and alkoxysilanes which have a hydroxyl group (i.e., —OH). An acryl-based silane may be selected from the group comprising beta-acryloxyethyl trimethoxysilane; beta-acryloxy propyl trimethoxysilane; gamma-acryloxyethyl trimethoxysilane; gamma-acryloxypropyl trimethoxysilane; beta-acryloxyethyl triethoxysilane; beta-acryloxypropyl triethoxysilane; gamma-acryloxyethyl triethoxysilane; gamma-acryloxypropyl triethoxysilane; beta-methacryloxyethyl trimethoxysilane; beta-methacryloxypropyl trimethoxysilane; gamma-methacryloxyethyl trimethoxysilane; gamma-methacryloxypropyl trimethoxysilane; beta-methacryloxyethyl triethoxysilane; beta-methacryloxypropyl triethoxysilane; gamma-methacryloxyethyl triethoxysilane; gamma-methacryloxypropyl triethoxysilane; 3-methacryloxypropylmethyl diethoxysilane. A vinyl-based silane may be selected from the group comprising vinyl trimethoxysilane; vinyl triethoxysilane; p-styryl trimethoxysilane, methylvinyldimethoxysilane, vinyldimethylmethoxysilane, divinyldimethoxysilane, vinyltris(2-methoxyethoxy)silane, and vinylbenzylethylenediaminopropyltrimethoxysilane. An aromatic silane may be selected from phenyltrimethoxysilane and phenyltriethoxysilane. An epoxy-based silane may be selected from the group comprising 3-glycydoxypropyl trimethoxysilane; 3-glycydoxypropylmethyl diethoxysilane; 3-glycydoxypropyl triethoxysilane; 2-(3,4-epoxycyclohexyl)ethyl trimethoxysilane, and glycidyloxypropylmethyldimethoxysilane. An amino-based silane may be selected from the group comprising 3-aminopropyl triethoxysilane; 3-aminopropyl trimethoxysilane; 3-aminopropyldimethyl ethoxysilane; 3-aminopropylmethyldiethoxysilane; 4-aminobutyltriethoxysilane; 3-aminopropyldiisopropyl ethoxysilane; 1-amino-2-(dimethylethoxysilyl)propane; (aminoethylamino)-3-isobutyldimethyl methoxysilane; N-(2-aminoethyl)-3-aminoisobutylmethyl dimethoxysilane; (aminoethylaminomethyl)phenetyl trimethoxysilane; N-(2-aminoethyl)-3-aminopropylmethyl dimethoxysilane; N-(2-aminoethyl)-3-aminopropyl trimethoxysilane; N-(2-aminoethyl)-3-aminopropyl triethoxysilane; N-(6-aminohexyl)aminomethyl trimethoxysilane; N-(6-aminohexyl)aminomethyl trimethoxysilane; N-(6-aminohexyl)aminopropyl trimethoxysilane; N-(2-aminoethyl)-1,1-aminoundecyl trimethoxysilane; 1,1-aminoundecyl triethoxysilane; 3-(m-aminophenoxy)propyl trimethoxysilane; m-aminophenyl trimethoxysilane; p-aminophenyl trimethoxysilane; (3-trimethoxysilylpropyl)diethylenetriamine; N-methylaminopropylmethyl dimethoxysilane; N-methylaminopropyl trimethoxysilane; dimethylaminomethyl ethoxysilane; (N,N-dimethylaminopropyl)trimethoxysilane; (N-acetylglycysil)-3-aminopropyl trimethoxysilane, N-phenyl-3-aminopropyltrimethoxysilane, N-phenyl-3-aminopropyltriethoxysilane, phenylaminopropyltrimethoxysilane, aminoethylaminopropyltrimethoxysilane, and aminoethylaminopropylmethyldimethoxysilane. An ureide-based silane may be 3-ureidepropyl triethoxysilane. A mercapto-based silane may be selected from the group comprising 3-mercaptopropylmethyl dimethoxysilane, 3-mercaptopropyl trimethoxysilane, and 3-mercaptopropyl triethoxysilane. An alkoxysilane having a hydroxyl group may be selected from the group comprising hydroxymethyl triethoxysilane; N-(hydroxyethyl)-N-methylaminopropyl trimethoxysilane; bis(2-hydroxyethyl)-3-aminopropyl triethoxysilane; N-(3-triethoxysilylpropyl)-4-hydroxy butylamide; 1,1-(triethoxysilyl)undecanol; triethoxysilyl undecanol; ethylene glycol acetal; and N-(3-ethoxysilylpropyl)gluconamide.

In some aspects, the alkylsilane may be expressed with a general formula: RₙSi(OR′)₄₋ₙ wherein: n is 1, 2 or 3; R is a C₁₋₂₀ alkyl or a C₂₋₂₀ alkenyl; and R′ is an C₁₋₂₀ alkyl. The term “alkyl” by itself or as part of another substituent, refers to a straight, branched or cyclic saturated hydrocarbon group joined by single carbon-carbon bonds having 1 to 20 carbon atoms, for example 1 to 10 carbon atoms, for example 1 to 8 carbon atoms, or for example 1 to 6 carbon atoms. When a subscript is used herein following a carbon atom, the subscript refers to the number of carbon atoms that the named group may contain. Thus, for example, C₁₋₆ alkyl means an alkyl of one to six carbon atoms. Examples of alkyl groups are methyl, ethyl, propyl, isopropyl, butyl, isobutyl, sec-butyl, t-butyl, 2-methylbutyl, pentyl, iso-amyl and its isomers, hexyl and its isomers, heptyl and its isomers, octyl and its isomer, decyl and its isomer, dodecyl and its isomers. The term “C₂₋₂₀alkenyl” by itself or as part of another substituent, refers to an unsaturated hydrocarbyl group, which may be linear, or branched, comprising one or more carbon-carbon double bonds having 2 to 20 carbon atoms. Examples of C₂₋₆ alkenyl groups are ethenyl, 2-propenyl, 2-butenyl, 3-butenyl, 2-pentenyl and its isomers, 2-hexenyl and its isomers, 2,4-pentadienyl and the like.

In some aspects, the alkylsilane may be selected from the group comprising methyltrimethoxysilane; methyltriethoxysilane; ethyltrimethoxysilane; ethyltriethoxysilane; propyltrimethoxysilane; propyltriethoxysilane; hexyltrimethoxysilane; hexyltriethoxysilane; octyltrimethoxysilane; octyltriethoxysilane; decyltrimethoxysilane; decyltriethoxysilane; dodecyltrimethoxysilane: dodecyltriethoxysilane; tridecyltrimethoxysilane; dodecyltriethoxysilane; hexadecyltrimethoxysilane; hexadecyltriethoxysilane; octadecyltrimethoxysilane; octadecyltriethoxysilane, trimethylmethoxysilane, methylhydrodimethoxysilane, dimethyldimethoxysilane, diisopropyldimethoxysilane, diisobutyldimethoxysilane, isobutyltrimethoxysilane, n-butyltrimethoxysilane, n-butylmethyldimethoxysilane, phenyltrimethoxysilane, phenyltrimethoxysilane, phenylmethyldimethoxysilane, triphenylsilanol, n-hexyltrimethoxysilane, n-octyltrimethoxysilane, isooctyltrimethoxysilane, decyltrimethoxysilane, hexadecyltrimethoxysilane, cyclohexylmethyldimethoxysilane, cyclohexylethyldimethoxysilane, dicyclopentyldimethoxysilane, tert-butylethyldimethoxysilane, tert-butylpropyldimethoxysilane, dicyclohexyldimethoxysilane, and a combination thereof.

In some aspects, the alkylsilane compound may be selected from triethoxyoctylsilane, trimethoxyoctylsilane, and a combination thereof.

Additional examples of silanes that can be used as silane crosslinkers include, but are not limited to, those of the general formula CH₂═CR—(COO)ₓ(CₙH₂ₙ)_{y}SiR′₃, wherein R is a hydrogen atom or methyl group; x is 0 or 1; y is 0 or 1; n is an integer from 1 to 12; each R′ can be an organic group and may be independently selected from an alkoxy group having from 1 to 12 carbon atoms (e.g., methoxy, ethoxy, butoxy), aryloxy group (e.g., phenoxy), araloxy group (e.g., benzyloxy), aliphatic acyloxy group having from 1 to 12 carbon atoms (e.g., formyloxy, acetyloxy, propanoyloxy), amino or substituted amino groups (e.g., alkylamino, arylamino), or a lower alkyl group having 1 to 6 carbon atoms. x and y may both equal 1. In some aspects, no more than one of the three R′ groups is an alkyl. In other aspects, no more than two of the three R′ groups is an alkyl.

Any silane or mixture of silanes known in the art that can effectively graft to and crosslink an olefin polymer can be used in the practice of the present disclosure. In some aspects, the silane crosslinker can include, but is not limited to, unsaturated silanes which include an ethylenically unsaturated hydrocarbyl group (e.g., a vinyl, allyl, isopropenyl, butenyl, cyclohexenyl or a gamma-(meth)acryloxy allyl group) and a hydrolyzable group (e.g., a hydrocarbyloxy, hydrocarbonyloxy, or hydrocarbylamino group). Non-limiting examples of hydrolyzable groups include, but are not limited to, methoxy, ethoxy, formyloxy, acetoxy, proprionyloxy, and alkyl, or arylamino groups. In other aspects, the silane crosslinkers are unsaturated alkoxy silanes which can be grafted onto the polymer. In still other aspects, additional exemplary silane crosslinkers include vinyltrimethoxysilane, vinyltriethoxysilane, 3-(trimethoxysilyl)propyl methacrylate gamma-(meth)acryloxypropyl trimethoxysilane), and mixtures thereof.

The silane crosslinker may be present in the silane-grafted polyolefin elastomer in an amount of from greater than 0 wt % to about 10 wt %, including from about 0.5 wt % to about 5 wt %. The amount of silane crosslinker may be varied based on the nature of the olefin polymer, the silane itself, the processing conditions, the grafting efficiency, the application, and other factors. The amount of silane crosslinker may be at least 2 wt %, including at least 4 wt % or at least 5 wt %, based on the weight of the reactive composition. In other aspects, the amount of silane crosslinker may be at least 10 wt %, based on the weight of the reactive composition. In still other aspects, the silane crosslinker content is at least 1% based on the weight of the reactive composition. In some embodiments, the silane crosslinker fed to the extruder may include from about 0.5 wt % to about 10 wt % of silane monomer, from about 1 wt % to about 5 wt % of silane monomer, or from about 2 wt % to about 4 wt % of silane monomer.

### Condensation Catalyst

A condensation catalyst can facilitate both the hydrolysis and subsequent condensation of the silane grafts on the silane-grafted polyolefin elastomer to form crosslinks. In some aspects, the crosslinking can be aided by the use of an electron beam radiation. In some aspects, the condensation catalyst can include, for example, organic bases, carboxylic acids, and organometallic compounds (e.g., organic titanates and complexes or carboxylates of lead, cobalt, iron, nickel, zinc, and tin). In other aspects, the condensation catalyst can include fatty acids and metal complex compounds such as metal carboxylates; aluminum triacetyl acetonate, iron triacetyl acetonate, manganese tetraacetyl acetonate, nickel tetraacetyl acetonate, chromium hexaacetyl acetonate, titanium tetraacetyl acetonate and cobalt tetraacetyl acetonate; metal alkoxides such as aluminum ethoxide, aluminum propoxide, aluminum butoxide, titanium ethoxide, titanium propoxide and titanium butoxide; metal salt compounds such as sodium acetate, tin octylate, lead octylate, cobalt octylate, zinc octylate, calcium octylate, lead naphthenate, cobalt naphthenate, dibutyltin dioctoate, dibutyltin dilaurate, dibutyltin maleate and dibutyltin di(2-ethylhexanoate); acidic compounds such as formic acid, acetic acid, propionic acid, p-toluenesulfonic acid, trichloroacetic acid, phosphoric acid, monoalkylphosphoric acid, dialkylphosphoric acid, phosphate ester of p-hydroxyethyl (meth)acrylate, monoalkylphosphorous acid and dialkylphosphorous acid; acids such as p-toluenesulfonic acid, phthalic anhydride, benzoic acid, benzenesulfonic acid, dodecylbenzenesulfonic acid, formic acid, acetic acid, itaconic acid, oxalic acid and maleic acid, ammonium salts, lower amine salts or polyvalent metal salts of these acids, sodium hydroxide, lithium chloride; organometal compounds such as diethyl zinc and tetra(n-butoxy)titanium; and amines such as dicyclohexylamine, triethylamine, N,N-dimethylbenzylamine, N,N,N′,N′-tetramethyl-1,3-butanediamine, diethanolamine, triethanolamine and cyclohexylethylamine. In still other aspects, the condensation catalyst can include ibutyltindilaurate, dioctyltin dilaurate (DOTL), monobutyltin oxide (MBTO), dioctyltinmaleate, dibutyltindiacetate, dibutyltindioctoate, dibutyltin dilaurate, stannous acetate, stannous octoate, lead naphthenate, zinc caprylate, and cobalt naphthenate. Depending on the desired final material properties of the silane-crosslinked polyolefin elastomer or blend, a single condensation catalyst or a mixture of condensation catalysts may be utilized. The condensation catalyst(s) may be present in an amount of from about 0.01 wt % to about 1.0 wt %, including from about 0.25 wt % to about 8 wt %, based on the total weight of the silane-grafted polyolefin elastomer/blend composition.

In some aspects, a crosslinking system can include and use one or all of a combination of radiation, heat, moisture, and additional condensation catalyst. In some aspects, the condensation catalyst may be present in an amount of from 0.25 wt % to 8 wt %. In other aspects, the condensation catalyst may be included in an amount of from about 1 wt % to about 10 wt % or from about 2 wt % to about 5 wt %.

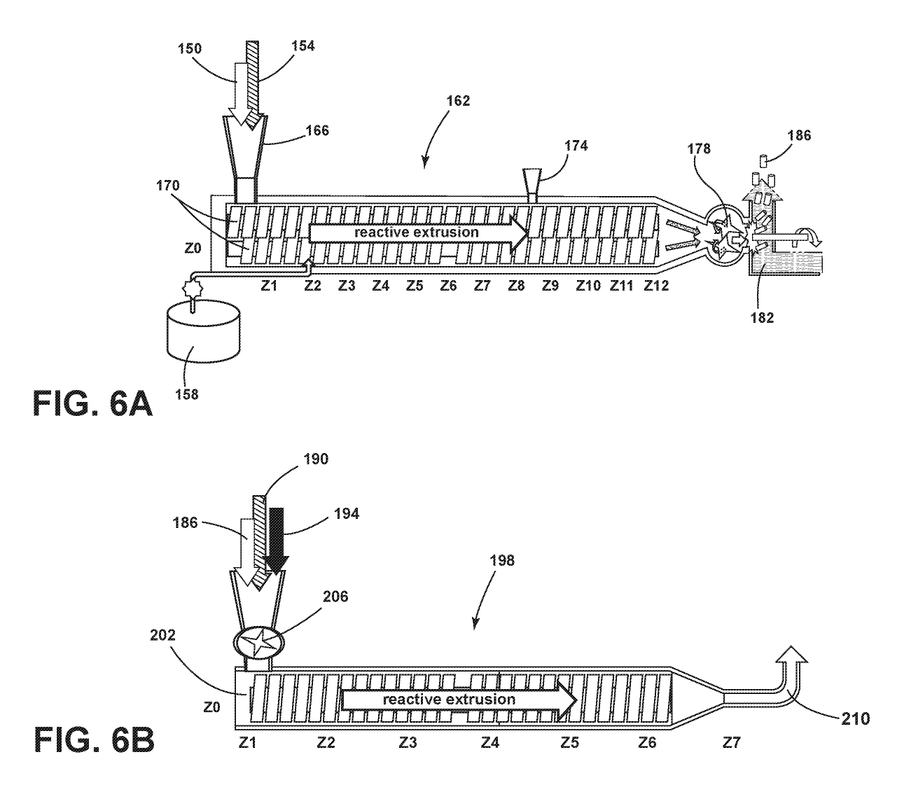

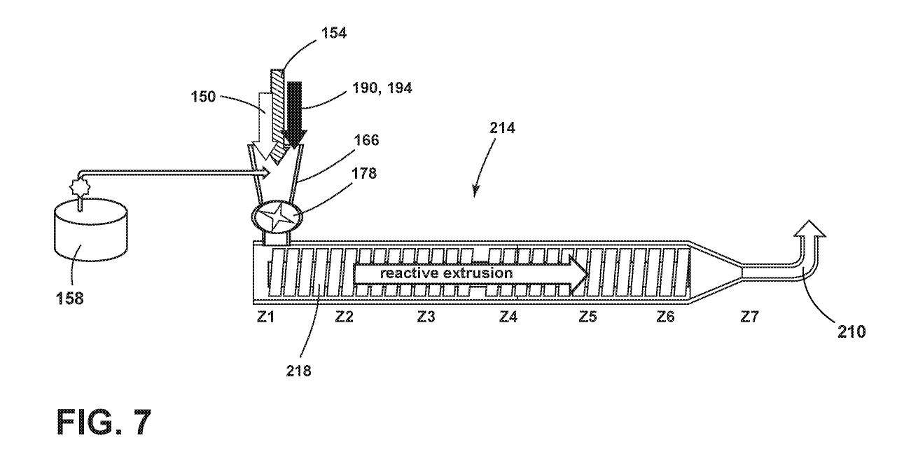

In some aspects, latent condensation catalysts are required that do not initiate and/or catalyze the hydrolysis and subsequent condensation of the silane grafts in the single screw extruder 198, 214 (see FIGS. 6B and 7, and their corresponding description) or in the ambient conditions after the silane-crosslinkable polyolefin elastomer is formed. When a latent condensation catalyst is required to delay silane graft condensation until it is exposed to higher temperatures and/or moisture levels, the latent condensation can include, for example, dioctyltin dilaurate (DOTL), monobutyltin oxide (MBTO), or a combination thereof.

### Optional Additional Components

The silane-crosslinked polyolefin elastomer may optionally include one or more fillers. In some aspects, the fillers that may be extruded with the silane-grafted polyolefin are meant to improve the modulus and tear properties of the silane-crosslinked polyolefin elastomer without increasing the density or specific gravity. Examples of reinforcement fillers that may be added to the silane-crosslinkable polyolefin elastomer include glass fibers, short aramid fibers, carbon nanowires, carbon nanotubes, nano silica, nano clays, graphene, nano platelets, and varieties of carbon allotropes.

In some aspects, the filler(s) may include metal oxides, metal hydroxides, metal carbonates, metal sulfates, metal silicates, clays, talcs, carbon black, and silicas. Depending on the application and/or desired properties, these materials may be fumed or calcined.

The filler(s) of the silane-crosslinked polyolefin elastomer or blend may be present in an amount of from greater than 0 wt % to about 50 wt %, including from about 1 wt % to about 20 wt %, and from about 3 wt % to about 10 wt %.

The silane-crosslinked polyolefin elastomer and/or the respective articles formed (e.g., hose 10 depicted in FIGS. 1-4) may also include waxes (e.g., paraffin waxes, microcrystalline waxes, HDPE waxes, LDPE waxes, thermally degraded waxes, byproduct polyethylene waxes, optionally oxidized Fischer-Tropsch waxes, and functionalized waxes). In some embodiments, the wax(es) are present in an amount of from about 0 wt % to about 10 wt %.

Tackifying resins (e.g., aliphatic hydrocarbons, aromatic hydrocarbons, modified hydrocarbons, terpens, modified terpenes, hydrogenated terpenes, rosins, rosin derivatives, hydrogenated rosins, and mixtures thereof) may also be included in the silane-crosslinker polyolefin elastomer/blend. The tackifying resins may have a ring and ball softening point in the range of from 70° C. to about 150° C. and a viscosity of less than about 3,000 cP at 177° C. In some aspects, the tackifying resin(s) are present in an amount of from about 0 wt % to about 10 wt %.

In some aspects, the silane-crosslinker polyolefin elastomer may include one or more oils. Non-limiting types of oils include white paraffinic oils, mineral oils, and/or naphthenic oils. In some embodiments, the oil(s) are present in an amount of from about 0 wt % to about 10 wt %.

In some aspects, the silane-crosslinked polyolefin elastomer may include one or more filler polyolefins having a crystallinity greater than 20%, greater than 30%, greater than 40%, or greater than 50%. The filler polyolefin may include polypropylene, poly(ethylene-co-propylene), and/or other ethylene/α-olefin copolymers. In some aspects, the use of the filler polyolefin may be present in an amount of from about 5 wt % to about 60 wt %, from about 10 wt % to about 50 wt %, from about 20 wt % to about 40 wt %, or from about 5 wt % to about 20 wt %. The addition of the filler polyolefin may increase the Young's modulus by at least 10%, by at least 25%, or by at least 50% for the final silane-crosslinked polyolefin elastomer.

In some aspects, the silane-crosslinker polyolefin elastomer of the present disclosure may include one or more stabilizers (e.g., antioxidants). The silane-crosslinked polyolefin elastomer may be treated before grafting, after grafting, before crosslinking, and/or after crosslinking. Other additives may also be included. Non-limiting examples of additives include antistatic agents, dyes, pigments, UV light absorbers, nucleating agents, fillers, slip agents, plasticizers, fire retardants, lubricants, processing aides, smoke inhibitors, anti-blocking agents, and viscosity control agents. The antioxidant(s) may be present in an amount of less than 0.5 wt %, including less than 0.2 wt % of the composition.

### Method for Making the Silane-Grafted Polyolefin Elastomer

The synthesis/production of the silane-crosslinked polyolefin elastomer may be performed by combining the respective components in one extruder using a single-step Monosil process or in two extruders using a two-step Sioplas process which eliminates the need for additional steps of mixing and shipping rubber compounds prior to extrusion.

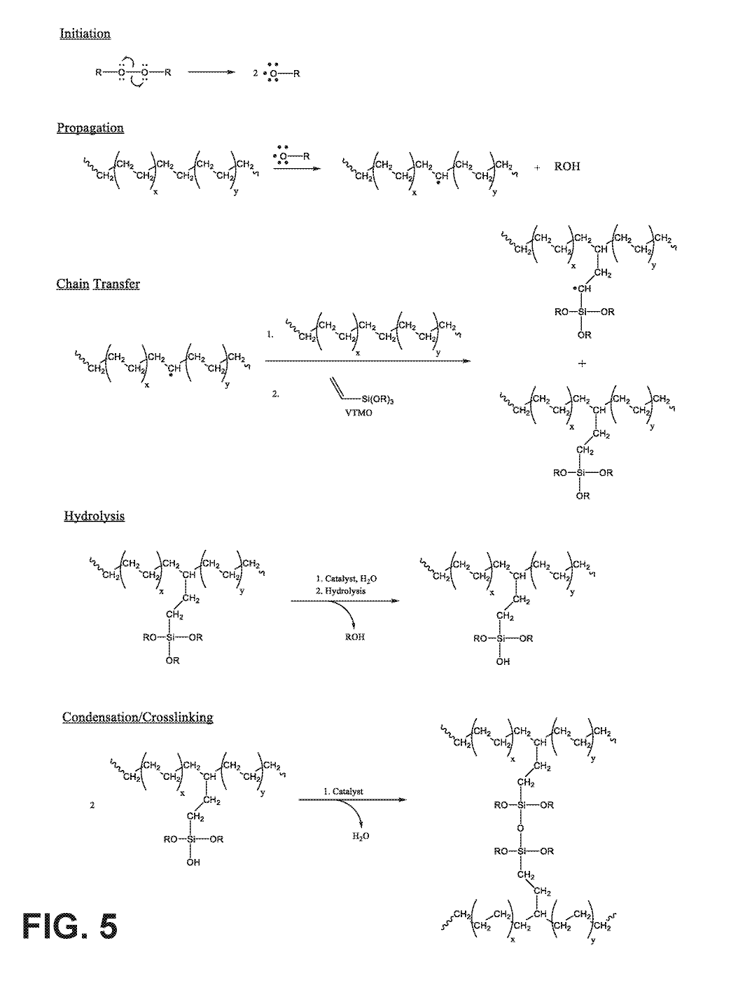

Referring now to FIG. 5, the general chemical process used during both the single-step Monosil process and two-step Sioplas process used to synthesize the silane-crosslinked polyolefin elastomer is provided. The process starts with a grafting step that includes initiation from a grafting initiator followed by propagation and chain transfer with the first and second polyolefins. The grafting initiator, in some aspects a peroxide or azo compound, homolytically cleaves to form two radical initiator fragments that transfer to one of the first and second polyolefins chains through a propagation step. The free radical, now positioned on the first or second polyolefin chain, can then transfer to a silane molecule and/or another polyolefin chain. Once the initiator and free radicals are consumed, the silane grafting reaction for the first and second polyolefins is complete.

Still referring to FIG. 5, once the silane grafting reaction is complete, a mixture of stable first and second silane-grafted polyolefins is produced. A crosslinking catalyst may then be added to the first and second silane-grafted polyolefins to form the silane-crosslinkable polyolefin elastomer. The crosslinking catalyst may first facilitate the hydrolysis of the silyl group grafted onto the polyolefin backbones to form reactive silanol groups. The silanol groups may then react with other silanol groups on other polyolefin molecules to form a crosslinked network of elastomeric polyolefin polymer chains linked together through siloxane linkages. The density of silane crosslinks throughout the silane-crosslinkable polyolefin elastomer can influence the material properties exhibited by the elastomer.

Referring now to FIG. 6A, a general approach to using the two-step Sioplas process is shown. The method begins with a first step that includes extruding (e.g., with a twin screw extruder 162) the first polyolefin 150 having a density less than 0.86 g/cm³, the second polyolefin 154, and a silan cocktail 158 including the silane crosslinker (e.g., vinyltrimethoxy silane, VTMO) and the grafting initiator (e.g. dicumyl peroxide) together to form a silane-grafted polyolefin blend. The first polyolefin 150 and second polyolefin 154 may be added to the reactive twin screw extruder 162 using an addition hopper 166. The silan cocktail 158 may be added to the twin screws 170 further down the extrusion line to help promote better mixing with the first and second polyolefin 150, 154 blend. A forced volatile organic compound (VOC) vacuum 174 may be used on the reactive twin screw extruder 162 to help maintain a desired reaction pressure. The twin screw extruder 162 is considered reactive because the radical initiator and silane crosslinker are reacting with and forming new covalent bonds with both the first and second polyolefins 150, 154. The melted silane-grafted polyolefin blend can exit the reactive twin screw extruder 162 using a gear pump 178 that injects the molten silane-grafted polyolefin blend into a water pelletizer 182 that can form a pelletized silane-grafted polyolefin blend 186. In some aspects, the molten silane-grafted polyolefin blend may be extruded into pellets, pillows, or any other configuration prior to the incorporation of the condensation catalyst 190 (see FIG. 6B) and formation of the final article (e.g., a hose 10 as shown in FIGS. 1-4).

The reactive twin screw extruder 162 can be configured to have a plurality of different temperature zones (e.g., Z0-Z12 as shown in FIG. 6A) that extend for various lengths of the twin screw extruder 162. In some aspects, the respective temperature zones may have temperatures ranging from about room temperature to about 180° C., from about 120° C. to about 170° C., from about 120° C. to about 160° C., from about 120° C. to about 150° C., from about 120° C. to about 140° C., from about 120° C. to about 130° C., from about 130° C. to about 170° C., from about 130° C. to about 160° C., from about 130° C. to about 150° C., from about 130° C. to about 140° C., from about 140° C. to about 170° C., from about 140° C. to about 160° C., from about 140° C. to about 150° C., from about 150° C. to about 170° C., and from about 150° C. to about 160° C. In some aspects, Z0 may have a temperature from about 60° C. to about 110° C. or no cooling; Z1 may have a temperature from about 120° C. to about 130° C.; Z2 may have a temperature from about 140° C. to about 150° C.; Z3 may have a temperature from about 150° C. to about 160° C.; Z4 may have a temperature from about 150° C. to about 160° C.; Z5 may have a temperature from about 150° C. to about 160° C.; Z6 may have a temperature from about 150° C. to about 160° C.; Z7 may have a temperature from about 150° C. to about 160° C.; and Z8-Z12 may have a temperature from about 150° C. to about 160° C.

In some aspects, the number average molecular weight of the silane-grafted polyolefin elastomers may be in the range of from about 4,000 g/mol to about 30,000 g/mol, including from about 5,000 g/mol to about 25,000 g/mol, and from about 6,000 g/mol to about 14,000 g/mol. The weight average molecular weight of the grafted polymers may be from about 8,000 g/mol to about 60,000 g/mol, including from about 10,000 g/mol to about 30,000 g/mol.

Referring now to FIG. 6B, the process next includes a third step of extruding the silane-grafted polyolefin blend 186 and a condensation catalyst 190 together to form a silane-crosslinkable polyolefin blend 210. In some aspects, one or more optional additives 194 may be added with the silane-grafted polyolefin blend 186 and the condensation catalyst 190 to adjust the final material properties of the silane-crosslinkable polyolefin blend 210. In this third step, the silane-grafted polyolefin blend 186 is mixed with a silanol-forming condensation catalyst 190 to form reactive silanol groups on the silane grafts that can subsequently crosslink when exposed to humidity and/or heat. In some aspects, the condensation catalyst 190 can include a mixture of sulfonic acid, antioxidant, process aide, and carbon black for coloring where the ambient moisture is sufficient for this condensation catalyst to crosslink the silane-crosslinkable polyolefin blend over a longer time period (e.g., about 48 hours). The silane-grafted polyolefin blend 186 and the condensation catalyst 190 may be added to a reactive single screw extruder 198 using an addition hopper (similar to addition hopper 166 shown in FIG. 6A) and an addition gear pump 206. The combination of the silane-grafted polyolefin blend 186 and the condensation catalyst 190, and in some aspects one or more optional additives 194, may be added to a single screw 202 of the reactive single screw extruder 198. The single screw extruder 198 is considered reactive because the silane-grafted polyolefin blend 186 and the condensation catalyst 190 are melted and combined together to mix the condensation catalyst 190 thoroughly and evenly throughout the melted silane-grafted polyolefin blend 186 to begin the crosslinked process. The melted silane-crosslinkable polyolefin blend 210 can exit the reactive single screw extruder 198 through a die that can inject the molten silane-crosslinkable polyolefin blend 210 into the form of an uncured hose element or a precursor form of the hose element. The uncured hose element can be referred to in the art as a green hose.

During the third step, as the silane-grafted polyolefin blend 186 is extruded together with the condensation catalyst 190 to form the silane-crosslinkable polyolefin blend 210, a certain amount of crosslinking may occur. In some aspects, the silane-crosslinkable polyolefin blend 210 may be about 25% cured, about 30% cured, about 35% cured, about 40% cured, about 45% cured, about 50% cured, about 55% cured, about 60% cured, about 65% cured, or about 70% cured, where a gel test (ASTM D2765) can be used to determine the amount of crosslinking in the final silane-crosslinked polyolefin elastomer. The partial curing of the silane-crosslinkable polyolefin elastomer or blend 210 can be referred to as the uncured hose element or green hose.

Still referring to the process presented in FIGS. 6A and 6B, the fourth step of crosslinking the silane-crosslinkable polyolefin blend 210 or the uncured hose element occurs once the uncured hose element is loaded on a mandrel and into an autoclave to impart elevated temperatures and/or elevated humidity to form the silane-crosslinked polyolefin elastomer making up the hose 10 having a density from about 0.88 g/cm³ to about 1.05 g/cm³. More particularly, in this crosslinking process, the water hydrolyzes the silane of the silane-crosslinkable polyolefin elastomer to produce a silanol. The silanol groups on various silane grafts can then be condensed to form intermolecular, irreversible Si—O—Si crosslink sites. The amount of crosslinked silane groups, and thus the final polymer properties, can be regulated by controlling the production process, including the amount of catalyst used. In aspects where the autoclave is used, the catalyst used can be latent and can include, for example, dioctyltin dilaurate (DOTL), monobutyltin oxide (MBTO), or a combination thereof.

The crosslinking/curing of step of this method may occur over a time period of from greater than 5 minutes to about 30 minutes at a steam pressure of 5 to 12 bars. In some aspects, curing takes place over a time period of from about 10 minutes to about 20 minutes, 10 minutes to about 2 hours, from about 15 minutes to about 1 hours, from about 5 minutes to about 15 minutes, from about 1 hour to about 8 hours, or from about 15 minutes to about 45 minutes. The temperature during the crosslinking/curing may be about room temperature, from about 20° C. to about 450° C., from about 25° C. to about 325° C., or from about 20° C. to about 175° C. The humidity during curing may be from about 30% to about 100%, from about 40% to about 100%, or from about 50% to about 100%.

In some aspects, an extruder setting is used that is capable of extruding thermoplastic, with long L/D, 30 to 1, at an extruder heat setting close to TPV processing conditions wherein the extrudate crosslinks at ambient conditions becoming a thermoset in properties. In other aspects, this process may be accelerated by steam exposure. Immediately after extrusion, the gel content (also called the crosslink density) may be about 60%, but after 96 hrs at ambient conditions, the gel content may reach greater than about 95%.

In some aspects, one or more reactive single screw extruders 198 (see FIG. 6B) may be used to form the uncured hose element which includes one or more types of silane-crosslinked polyolefin elastomers. For example, in some aspects, one reactive single screw extruder 198 may be used to produce and extrude the silane-crosslinkable polyolefin elastomer of the outer layer 14 while a second reactive single screw extruder 198 may be used to produce and extrude the silane-crosslinkable polyolefin elastomer of the inner layer 18 of the hose 10 (see FIGS. 1-4). The complexity and layering of the final hose 10 can determine the number and types of reactive single screw extruders 198 required.

It is understood that the principles of the disclosure outlining and teaching the various hoses 10, and their respective components and compositions, can be used in any combination, and applies equally well to the method for making the hose 10 using the two-step Sioplas process as shown in FIGS. 6A and 6B.

Referring now to FIG. 7, a method for making the hose 10 using the one-step Monosil process is shown. The Monosil method may begin with a first step that includes extruding (e.g., with a single screw extruder 214) the first polyolefin 150 having a density less than 0.86 g/cm³, the second polyolefin 154, the silan cocktail 158 including the the silane crosslinker (e.g., vinyltrimethoxy silane, VTMO) and grafting initiator (e.g. dicumyl peroxide), and the condensation catalyst 190 together to form the crosslinkable silane-grafted polyolefin blend 210. The first polyolefin 150, second polyolefin 154, and silan cocktail 158 may be added to the reactive single screw extruder 214 using an addition hopper 166 and gear pump 178. In some aspects, the silan cocktail 158 may be added to a single screw 218 of the extruder 214 further down the extrusion line to help promote better mixing or contact with the first and second polyolefin 150, 154 blend. In some aspects, one or more optional additives 194 may be added with the first polyolefin 150, second polyolefin 154, and silan cocktail 158 to adjust the final material properties of the silane-crosslinkable polyolefin blend 210. The single screw extruder 214 is considered reactive because the radical initiator and silane crosslinker of the silan cocktail 158 are reacting with and forming new covalent bonds with both the first and second polyolefins 150, 154. In addition, the reactive single screw extruder 214 mixes the condensation catalyst 190 in together with the melted silane-grafted polyolefin blend. The melted silane-crosslinkable polyolefin blend 210 can exit the reactive single screw extruder 214 using a gear pump (not shown) and/or die that can eject the molten silane-crosslinkable polyolefin blend 210 into the form of an uncured hose element or a precursor to the same.

During the first step, as the first polyolefin 150, second polyolefin 154, silan cocktail 158, and condensation catalyst 190 are extruded together, a certain amount of crosslinking may occur in the reactive single screw extruder 214. In some aspects, the silane-crosslinkable polyolefin blend 210 may be about 25% cured, about 30% cured, about 35% cured, about 40% cured, about 45% cured, about 50% cured, about 55% cured, about 60% cured, about 65% cured, or about 70% cured, as it leaves the reactive single screw extruder 214. A gel test (ASTM D2765) can be used to determine the amount of crosslinking in the final silane-crosslinked polyolefin elastomer.

The reactive single screw extruder 214 can be configured to have a plurality of different temperature zones (e.g., Z0-Z7 as shown in FIG. 7) that extend for various lengths along the extruder. In some aspects, the respective temperature zones may have temperatures ranging from about room temperature to about 180° C., from about 120° C. to about 170° C., from about 120° C. to about 160° C., from about 120° C. to about 150° C., from about 120° C. to about 140° C., from about 120° C. to about 130° C., from about 130° C. to about 170° C., from about 130° C. to about 160° C., from about 130° C. to about 150° C., from about 130° C. to about 140° C., from about 140° C. to about 170° C., from about 140° C. to about 160° C., from about 140° C. to about 150° C., from about 150° C. to about 170° C., and from about 150° C. to about 160° C. In some aspects, Z0 may have a temperature from about 60° C. to about 110° C. or no cooling; Z1 may have a temperature from about 120° C. to about 130° C.; Z2 may have a temperature from about 140° C. to about 150° C.; Z3 may have a temperature from about 150° C. to about 160° C.; Z4 may have a temperature from about 150° C. to about 160° C.; Z5 may have a temperature from about 150° C. to about 160° C.; Z6 may have a temperature from about 150° C. to about 160° C.; and Z7 may have a temperature from about 150° C. to about 160° C.

In some aspects, the number average molecular weight of the silane-grafted polyolefin elastomers may be in the range of from about 4,000 g/mol to about 30,000 g/mol, including from about 5,000 g/mol to about 25,000 g/mol and from about 6,000 g/mol to about 14,000 g/mol. The weight average molecular weight of the grafted polymers may be from about 8,000 g/mol to about 60,000 g/mol, including from about 10,000 g/mol to about 30,000 g/mol.

Still referring to FIG. 7, the method further includes a second step of molding or otherwise forming the silane-crosslinkable polyolefin blend into the uncured hose element or green hose. The reactive single screw extruder 214 can melt and extrude the silane-crosslinkable polyolefin through a die (not shown) that can eject the molten silane-crosslinkable polyolefin blend 210 into the uncured hose element, which is subsequently cured into the hose 10 (see FIGS. 1-4) in the crosslinking step described as follows.

Still referring to FIG. 7, the Monosil method can further include a third step of crosslinking the silane-crosslinkable polyolefin blend 210 of the uncured hose element/green hose. In particular, the green hose can be loaded on a mandrel, in some aspects, and heated in an autoclave at elevated temperatures and humidity to form it into a hose 10 having a density from about 0.85 g/cm³ to about 0.89 g/cm³. The amount of crosslinked silane groups, and thus the final polymer properties, can be regulated by controlling the production process, including the amount of catalyst used. In aspects where an autoclave is used, the catalyst used can be latent and can include, for example, dioctyltin dilaurate (DOTL), monobutyltin oxide (MBTO), or a combination thereof.

The third step of crosslinking the silane-crosslinkable polyolefin blend may occur over a time period of from greater than 5 minutes to about 30 minutes at a steam pressure of 5 to 12 bars. In some aspects, curing takes place over a time period of from about 10 minutes to about 20 minutes, 10 minutes to about 2 hours, from about 15 minutes to about 1 hours, from about 5 minutes to about 15 minutes, from about 1 hour to about 8 hours, or from about 15 minutes to about 45 minutes. The temperature during the crosslinking/curing may be about room temperature, from about 20° C. to about 450° C., from about 25° C. to about 325° C., or from about 20° C. to about 175° C. The humidity during curing may be from about 30% to about 100%, from about 40% to about 100%, or from about 50% to about 100%.

In some aspects, an extruder setting is used that is capable of extruding thermoplastic, with long L/D, 30 to 1, at an extruder heat setting close to TPV processing conditions wherein the extrudate crosslinks at ambient conditions becoming a thermoset in properties. In other aspects, this process may be accelerated by steam exposure. Immediately after extrusion, the gel content (also called the crosslink density) may be about 60%, but after 96 hrs at ambient conditions, the gel content may reach greater than about 95%.

In some aspects, one or more reactive single screw extruders 214 (see FIG. 7) may be used to form an uncured hose element having one or more types of silane-crosslinked polyolefin elastomers, which subsequently define a hose 10. For example, in some aspects, one reactive single screw extruder 214 may be used to produce and extrude a first silane-crosslinked polyolefin elastomer while a second reactive single screw extruder 214 may be used to produce and extrude a second silane-crosslinked polyolefin elastomer. The complexity and architecture of the final hose 10 can determine the number and types of reactive single screw extruders 214.

It is understood that the prior description outlining and teaching the various hoses 10, and their respective components and compositions, can be used in any combination, and applies equally well to the method for making the hose 10 using the one-step Monosil process as shown in FIG. 7.

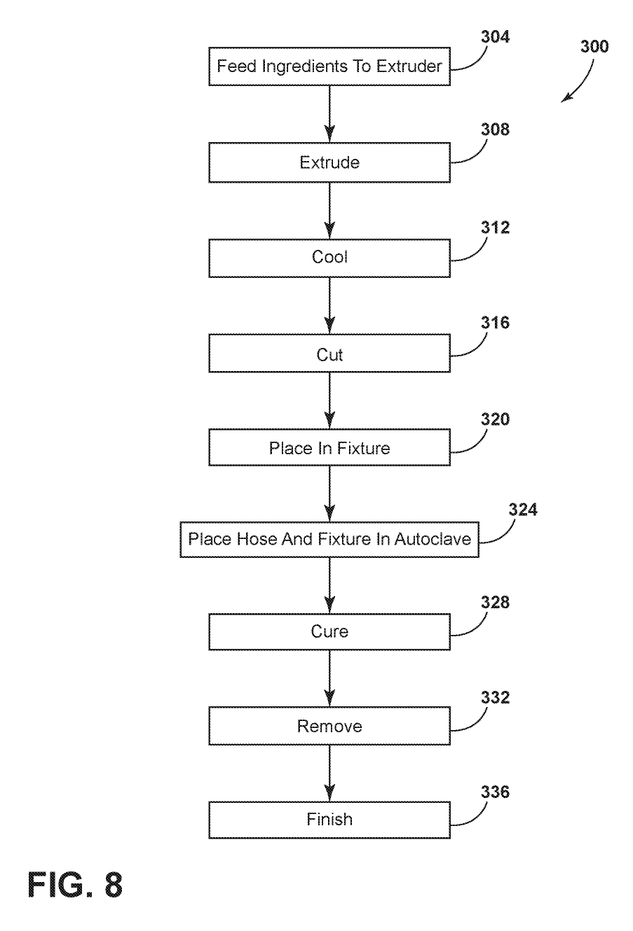

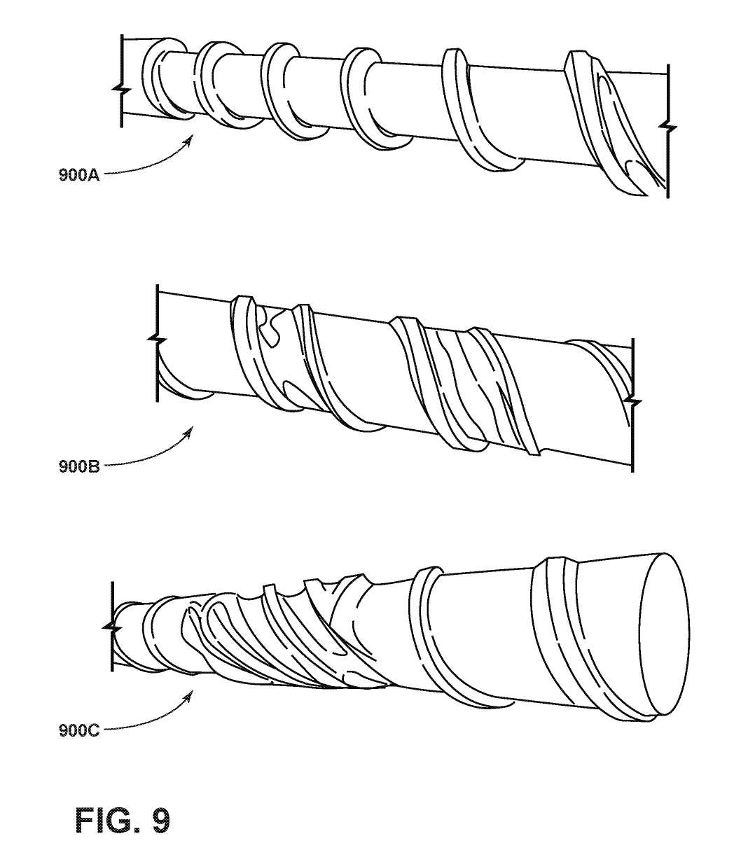

Referring now to FIG. 8, a method 300 for making the hose 10 is provided. The method 300 may begin with a step 304 of feeding the first and second olefins 150, 154, the silan cocktail 158, and the condensation catalyst 190 to an extruder 214 if using the Monosil technique depicted in FIG. 7. In other aspects, the method 300 may begin with a step 304 of feeding the silane-grafted polyolefin elastomer 186 and the condensation catalyst 190 to the extruder 198 if using the Sioplas technique shown in FIGS. 6A and 6B. In some aspects, the ingredients can be fed to the extruder in pelletized form. In some aspects, the extruder may be a single extruder, a twin screw extruder, or include three or more screws. FIG. 9 depicts sample embodiments of a feed end (900A), a mid-section (900B), and a tip (900C) of an exemplary extruder screw in accordance with some aspects of the present disclosure.

Referring again to FIG. 8, the method 300 further includes a step 308 of extruding the first and second olefins 150, 154, the silan cocktail 158, and the condensation catalyst 190 in the Monsil technique (FIG. 7) or extruding the silane-grafted polyolefin elastomer 186 and the condensation catalyst 190 using the Sioplas technique (FIGS. 6A and 6B). In some aspects, additional additives may be extruded with the components listed above for both the Monosil and Sioplas techniques. During the extrusion step 308, the zone temperatures of the respective extruders can vary with extruder type, setup, and compound/formulation. In some embodiments, the extruder zone temperatures are set at temperatures of from about 75° C. to about 120° C., from about 82° C. to about 105° C., or from about 87° C. to about 98° C. The extrudate temperature may be in the range of from about 82° C. to about 105° C. or from about 87° C. to about 98° C. Material residence time in the extruder varies with extruder type, extruder setup, extruder RPM (high RPM=shorter residence time) and compound/formulation. In some aspects, the residence time is from about 2 to about 20 minutes, from about 5 to about 15 minutes, or from about 5 to about 10 minutes.

During step 308, the hose 10 may be reinforced by the textile reinforcement layer 22 (see FIGS. 1-4) in order to achieve good pressure resistance (e.g., 3 bars, 4 bars, 5 bars, or 10 bars at 150° C.). The silane-grafted polyolefin elastomer may be extruded with a thermoplastic extruder at a temperature of from about 130° C. to about 220° C. (e.g., from about 125° C. to about 145° C.).

Still referring to FIG. 8, the method 300 can include a step 312 of cooling the extruded material or silane-crosslinkable polyolefin elastomer. The material may be passively or actively cooled using techniques known in the art. In some aspects, the extruded material or silane-crosslinkable polyolefin elastomer may be cooled to about 100° C., about 90° C., about 80° C., about 70° C., or about 60° C. In some aspects, the cooling process may take from about 2 minutes to about 2 hours, from about 2 minutes to about 1 hour, from about 2 minutes to about 20 minutes, from about 5 minutes to about 15 minutes, or from about 5 minutes to about 10 minutes.

The method 300 depicted in FIG. 8 further includes a step 316 of cutting the extruded material or silane-crosslinkable polyolefin elastomer to form a hose element. The desired shape of the hose element (which becomes the hose 10) may be obtained using a mandrel or external form or mold in some aspects. In some aspects, the extruded material or silane-crosslinkable polyolefin elastomer may be blown into a mold to form the hose element.

The method 300 can further include a step 320 of placing the cooled hose element in a fixture to form a desired shape and a step 324 of placing the hose element into an autoclave. In some aspects, since the volumes of the final hoses 10 are high, green, uncured hose elements may be kept at ambient conditions for up to a week. In such aspects, a delayed action catalyst and/or a dual cure catalyst using a peroxide for example may be used in these or any other aspects described herein, so the curing takes place only at higher temperature in presence of moisture (steam). Some non-limiting examples of delayed action catalysts or latent catalysts can include dioctyltin dilaurate (DOTL), monobutyltin oxide (MBTO), or a combination thereof.

Still referring to FIG. 8, the method 300 can include a step 328 of curing the hose element with pressurized hot steam. As such, step 328 crosslinks the silane-crosslinkable polyolefin elastomer in the hose element to form a silane-crosslinked polyolefin elastomer, thus forming the hose 10. In some aspects, high pressure steam is used to cure the silane-crosslinkable polyolefin elastomer to manage the handling of the uncured green hose element storage. If a mandrel is used immediately, then curing may begin to occur immediately at ambient conditions. In other aspects, the reticulation of the silane-crosslinkable polyolefin elastomer is performed at room temperature with ambient humidity (one to a few days cure time, for example), in hot water, (one to a few hours at 20° C. to 90° C.), or in steam (1 to 4 hours at a pressure from 1 to 5 bars).

The method 300 further include a step 332 of removing the hose from the autoclave and a step 336 of finishing the hose 10. The finishing step 336 may include trimming, overmolding, adding reducers, clamps, alignment marking, protective sleeves or connection of multiple hoses to form an assembly. In some aspects, the hoses 10 are equipped with quick connectors instead of clamps.

It is understood that the prior description outlining and teaching the various hoses 10 and their respective components and compositions, can be used in any combination, and applies equally well to the method 300 for making the hose 10 depicted in FIG. 8.

Non-limiting examples of articles that the silane-crosslinked polyolefin elastomers of the current disclosure may be used to manufacture include automotive hoses such as coolant hoses, air conditioning hoses, vacuum hoses. The silane-crosslinked polyolefin elastomer may also be used to manufacture water hoses, hot water and steam hoses, beverage and food hoses, air hoses, ventilation hoses, material handling hoses, oil transmission hoses, and chemical hoses.

### Silane-Crosslinked Polyolefin Elastomer Physical Properties

A “thermoplastic”, as used herein, is defined to mean a polymer that softens when exposed to heat and returns to its original condition when cooled to room temperature. A “thermoset”, as used herein, is defined to mean a polymer that solidifies and irreversibly “sets” or “crosslinks” when cured. In either of the Monosil or Sioplas processes described above, it is important to understand the careful balance of thermoplastic and thermoset properties of the various different materials used to produce the final thermoset silane-crosslinked polyolefin elastomer or hose 10. Each of the intermediate polymer materials mixed and reacted using a reactive twin screw extruder, and/or a reactive single screw extruder are thermosets. Accordingly, the silane-grafted polyolefin blend and the silane-crosslinkable polyolefin blend are thermoplastics and can be softened by heating so the respective materials can flow. Once the silane-crosslinkable polyolefin blend is extruded, molded, pressed, and/or shaped into the uncured hose element or other respective article, the silane-crosslinkable polyolefin blend can begin to crosslink or cure at an ambient temperature and an ambient humidity to form the hose 10 and silane-crosslinked polyolefin blend.

The thermoplastic/thermoset behavior of the silane-crosslinkable polyolefin blend and corresponding silane-crosslinked polyolefin blend are important for the various compositions and articles disclosed herein (e.g., hose 10 shown in FIGS. 1-4) because of the potential energy savings provided using these materials. For example, a manufacturer can save considerable amounts of energy by being able to cure the silane-crosslinkable polyolefin blend at an ambient temperature and an ambient humidity. This curing process is typically performed in the industry by applying significant amounts of energy to heat or steam treat crosslinkable polyolefins. The ability to cure the inventive silane-crosslinkable polyolefin blend with ambient temperature and/or ambient humidity are not properties necessarily intrinsic to crosslinkable polyolefins, but rather is a property dependent on the relatively low density of the silane-crosslinkable polyolefin blends of this disclosure. In some aspects, no additional curing ovens, heating ovens, steam ovens, or other forms of heat producing machinery other than what was provided in the extruders are used to form the silane-crosslinked polyolefin elastomers.

The specific gravity of the silane-crosslinked polyolefin elastomer of the present disclosure may be lower than the specific gravities of existing TPV and EPDM formulations used in the art. The reduced specific gravity of these materials can lead to lower weight parts, thereby helping automakers meet increasing demands for improved fuel economy. For example, the specific gravity of the silane-crosslinked polyolefin elastomer of the present disclosure may be from about 0.88 g/cm³ to about 1.05 g/cm³, from about 0.92 g/cm³ to about 1.00 g/cm³, from about 0.95 g/cm³ to about 0.98 g/cm³, about 0.88 g/cm³, about 0.90 g/cm³, about 0.92 g/cm³, about 0.94 g/cm³, about 0.96 g/cm³, about 0.98 g/cm³, about 1.00 g/cm³, about 1.02 g/cm³, or about 1.04 g/cm³. Hence, these specific gravities stand in contrast to existing TPV materials which may have a specific gravity of from 1.2 to 1.9 g/cm³, and existing EPDM materials which may have a specific gravity of from 1.1 to 2.25 g/cm³.

An exemplary silane-crosslinked polyolefin elastomer of the disclosure displays a smaller area between its stress/strain curves as compared to the areas between the stress/strain curves for existing TPV and EPDM compounds. This smaller area between the stress/strain curves for the silane-crosslinked polyolefin elastomer can be desirable for hose 10 applications. Elastomeric materials typically have non-linear stress/strain curves with a significant loss of energy when repeatedly stressed. The silane-crosslinked polyolefin elastomers of the present disclosure may exhibit greater elasticity and less viscoelasticity (e.g., have linear curves and exhibit very low energy loss). Embodiments of the silane-crosslinked polyolefin elastomers described herein do not have any filler or plasticizer incorporated into these materials so their corresponding stress/strain curves do not have or display any Mullins effect and/or Payne effect. The lack of Mullins effect for these silane-crosslinked polyolefin elastomers is due to the lack of any filler or plasticizer added to the silane-crosslinked polyolefin blend so the stress/strain curve does not depend on the maximum loading previously encountered where there is no instantaneous and irreversible softening. The lack of Payne effect for these silane-crosslinked polyolefin elastomers is due to the lack of any filler or plasticizer added to the silane-crosslinked polyolefin blend so the stress/strain curve does not depend on the small strain amplitudes previously encountered where there is no change in the viscoelastic storage modulus based on the amplitude of the strain.

The silane-crosslinked polyolefin elastomer or hose 10 can exhibit a compression set of from about 5.0% to about 30.0%, from about 5.0% to about 25.0%, from about 5.0% to about 20.0%, from about 5.0% to about 15.0%, from about 5.0% to about 10.0%, from about 10.0% to about 25.0%, from about 10.0% to about 20.0%, from about 10.0% to about 15.0%, from about 15.0% to about 30.0%, from about 15.0% to about 25.0%, from about 15.0% to about 20.0%, from about 20.0% to about 30.0%, or from about 20.0% to about 25.0%, as measured according to ASTM D 395 Method B (22 hrs @ 23° C., 70° C., 80° C., 90° C., 125° C., and/or 175° C.).

In other implementations, the silane-crosslinked polyolefin elastomer or hose 10 can exhibit a compression set of from about 5.0% to about 20.0%, from about 5.0% to about 15.0%, from about 5.0% to about 10.0%, from about 7.0% to about 20.0%, from about 7.0% to about 15.0%, from about 7.0% to about 10.0%, from about 9.0% to about 20.0%, from about 9.0% to about 15.0%, from about 9.0% to about 10.0%, from about 10.0% to about 20.0%, from about 10.0% to about 15.0%, from about 12.0% to about 20.0%, or from about 12.0% to about 15.0%, as measured according to ASTM D 395 Method B (22 hrs @ 23° C., 70° C., 80° C., 90° C., 125° C., and/or 175° C.).

The silane-crosslinked polyolefin elastomer or hose 10 may exhibit a crystallinity of from about 5% to about 40%, from about 5% to about 25%, from about 5% to about 15%, from about 10% to about 20%, from about 10% to about 15%, or from about 11% to about 14% as determined using density measurements, differential scanning calorimetry (DSC), X-Ray Diffraction (XRD), infrared spectroscopy, and/or solid state nuclear magnetic spectroscopy. As disclosed herein, DSC was used to measure the enthalpy of melting in order to calculate the crystallinity of the respective samples.

The silane-crosslinked polyolefin elastomer or hose 10 may exhibit a glass transition temperature of from about −75° C. to about −25° C., from about −65° C. to about −40° C., from about −60° C. to about −50° C., from about −50° C. to about −25° C., from about −50° C. to about −30° C., or from about −45° C. to about −25° C. as measured according to differential scanning calorimetry (DSC) using a second heating run at a rate of 5° C./min or 10° C./min.

The silane-crosslinked polyolefin elastomer or hose 10 may exhibit a weathering color difference of from about 0.25 ΔE to about 2.0 ΔE, from about 0.25 ΔE to about 1.5 ΔE, from about 0.25 ΔE to about 1.0 ΔE, or from about 0.25 ΔE to about 0.5 ΔE, as measured according to ASTM D2244 after 3000 hrs exposure to exterior weathering conditions.

The silane-crosslinked polyolefin elastomer or hose 10 may have a wall thickness of from about 1 millimeter to about 8 millimeters, about 1 millimeter to about 4 millimeters, from about 2 millimeters to about 6 millimeters, or about 1.5 millimeter to about 2.5 millimeters.

The silane-crosslinked polyolefin elastomer or hose 10 may have a −30% change, a −20% change, or a −10% change with regards to Heat Age measured for 168 hrs at 175° C.

The silane-crosslinked polyolefin elastomer or hose 10 may have a resistivity less than 1.0×10⁹ Ohms, resistivity less than 8.0×10¹⁰ Ohms, resistivity less than 5.0×10¹⁰ Ohms, or resistivity less than 2.0×10⁹ Ohms.

The silane-crosslinked polyolefin elastomer or hose 10 may have an abrasion volume change (AV) of less than 200 mm³, less than 100 mm³, less than 75 mm³, less than 50 mm³, or less than 25 mm³, as measured according to a William's Abrasion Testing method (JIS K6242) using a rotation speed of 37±3 rpm, a load of 35.5N, and a testing time of 6 minutes.

### EXAMPLES

The following examples represent certain non-limiting examples of the hoses, compositions and methods of making them, according to the disclosure.

### Materials

All chemicals, precursors and constituents were obtained from commercial suppliers and used as provided without further purification.

### Example 1

Example 1 (Ex. 1) or ED 92-GF was produced by extruding 34.20 wt % ENGAGE™ 8842, 41.20 wt % ENGAGE™ XLT8677 or XUS 38677.15, 14.50 wt % and 19.34 wt % MOSTEN™ TB 003, and 7.50 wt % RHS14/033 (35% GF) with 2.6 wt % SILAN RHS14/032 or SILFIN 29 to form the silane-grafted polyolefin elastomer. The Example 1 silane-grafted polyolefin elastomer was then extruded with dioctyltin dilaurate (DOTL) condensation catalyst to form a silane-crosslinkable polyolefin elastomer that can be molded or extruded into an uncured hose element. The Example 1 silane-crosslinkable polyolefin elastomer was cured at ambient temperature and humidity to form the corresponding silane-crosslinked polyolefin elastomer. The composition of Example 1 and acceptable composition ranges for the various elements of this example are provided in Table 1 below. The material properties of Example 1 are provided in Table 2 below, the provided material properties are representative of those shared by each of the silane-crosslinked polyolefin elastomers disclosed herein.

The composition of Example 1 may be cured using 200 ppm to about 500 ppm dioctyltin dilaurate (DOTL) catalyst system. ENGAGE™ 8842 polyolefin elastomer is an ultra-low density ethylene-octene copolymer. ENGAGE™ XLT8677 polyolefin elastomer is an ethylene-octene copolymer that is added to function as an impact modifier. MOSTEN™ TB 003 is a polypropylene homopolymer. RHS 14/033 is an ethylene-octene copolymer having 35 wt % glass fibers. SILAN RHS 14/032 and SILFIN 29 are both blends of a vinyltrimethoxysilane monomer and a peroxide molecule for grafting and crosslinking the various polyolefins added to the blend.

TABLE 1

| | Relative | First | Second |
|---|---|---|---|
| | Amount | range | range |
| Component | (wt %) | (wt %) | (wt %) |
| ENGAGE 8842 | 34.20 | 20-50 | 30-40 |
| ENGAGE XLT8677 | 41.20 | 20-60 | 35-45 |
| (XUS 38677.15) | | | |
| MOSTEN TB 003 | 14.50 | 5-25 | 10-20 |
| RHS14/033 (35% GF) | 7.50 | 2-20 | 5-10 |
| SILAN RHS14/032 or | 2.60 | 1-10 | 2-3 |
| SILFIN 29 | | | |
| Total | 100 | 100 | 100 |

TABLE 2

| Property | Test | Method | Units/Output | Ex. 1 |
|---|---|---|---|---|
| Originals | Hardness | ASTM D412 Die C | Shore A | 74 |
| | Tensile | ASTM D412 Die C | Mpa | 9.3 |
| | Elongation | ASTM D412 Die C | % | 301 |
| | Tear C | ASTM D624 Die C | N/mm | 33.4 |
| Delft Tear | Ambient Delft Tear | ISO 34-2 | N | 44.3 |
| | 100° C. Delft Tear | ISO 34-2 | N | 14.8 |
| | 125° C. Delft Tear | ISO 34-2 | N | 9.4 |
| | 135° C. Delft Tear | ISO 34-2 | N | 8.5 |
| Heat Age | Hardness Heat Age (1000 h/120° C.) | ASTM D573 | Change | −1 |
| | | | (Shore A) | |
| | Tensile Heat Age (1000 h/120° C.) | ASTM D573 | % Change | 9.1 |
| | Elongation Heat Age (1000 h/120° C.) | ASTM D573 | % Change | −28.2 |
| | Hardness Heat Age (168 h/135° C.) | ASTM D573 | Change | -1 |
| | | | (Shore A) | |
| | Tensile Heat Age (168 h/135° C.) | ASTM D573 | % Change | 6.5 |
| | Elongation Heat Age (168 h/135° C.) | ASTM D573 | % Change | −17 |
| | Hardness Heat Age (1000 h/135° C.) | ASTM D573 | Change | −3 |
| | | | (Shore A) | |
| | Tensile Heat Age (1000 h/135° C.) | ASTM D573 | % Change | 20.8 |
| | Elongation Heat Age (1000 h/135° C.) | ASTM D573 | % Change | −25.5 |
| | Hardness Heat Age (168 h/150° C.) | ASTM D573 | Change | 0 |
| | | | (Shore A) | |
| | Tensile Heat Age (168 h/150° C.) | ASTM D573 | % Change | −1.3 |
| | Elongation Heat Age (168 h/150° C.) | ASTM D573 | % Change | −33 |
| Compression | Plied C/S (22 h/80° C.) | ASTM D395 | % | 28 |
| Set | | Method B | | |
| Misc. | Weathering (3000 hrs.) | SAE J2527 | AATCC | 4-5 (pass) |

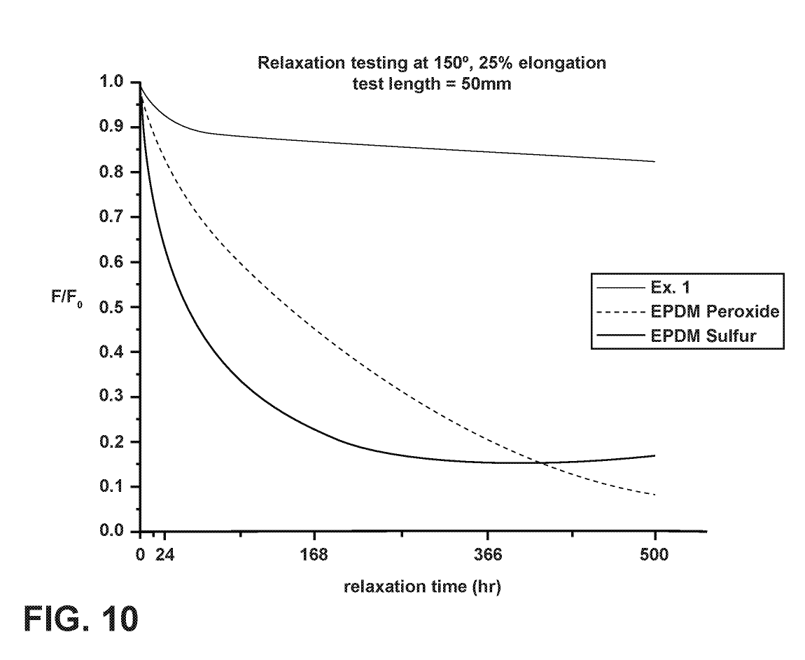

Referring now to FIG. 10, the thermal stability of Example 1 is provided with respect to a comparative EPDM peroxide crosslinked resin and a comparative EPDM sulfur crosslinked resin. As shown, Example 1 can retain nearly 90% of its elastic properties at 150° C. for greater than 500 hrs. The retention of elastic properties as provided in Example 1 is representative of each of the inventive silane-crosslinked polyolefin elastomers disclosed herein. A hose made from these silane-crosslinked polyolefin elastomers may retain up to 60%, 70%, 80%, or 90% of its elastic properties as determined by using Stress Relaxation measurements at 150° C. for greater than 100 hrs, greater than 200 hrs, greater than 300 hrs, greater than 400 hrs, and greater than 500 hrs.

### Example 2

Example 2 or ED 116 was produced by extruding 29.34 wt % ENGAGE™ 8150, 68.46 wt % INFUSE™ 9107, 0.20 wt % CHIMASSORB™ 2020 FDL, 0.10 wt % IRGANOX™ 1010, 0.05 wt % IRGAFOS 168, 1.40 wt % KETTLITZ™ TAIC liquid, 0.20 wt % IRGANOX™ 1330 together with 0.25 wt % IRGANOX™ MD 102 to form the silane-grafted polyolefin elastomer. The Example 2 silane-grafted polyolefin elastomer was then extruded with 200 ppm to about 500 ppm dioctyltin dilaurate (DOTL) condensation catalyst to form a silane-crosslinkable polyolefin elastomer, which can subsequently be extruded into an uncured hose element. The Example 2 silane-crosslinkable polyolefin elastomer was cured at ambient temperature and humidity to form the corresponding silane-crosslinked polyolefin elastomer. The composition of Example 2 and acceptable composition ranges for the various elements are provided in Table 3 below.

ENGAGE™ 8150 polyolefin elastomer is an ethylene-octene copolymer. INFUSE™ 9107 is a low density olefin block copolymer. CHIMASORB™ 2020 FDL is a high molecular weight hindered amine light stabilizer (HALS). IRGANOX™ 1010 is a sterically hindered phenolic antioxidant (pentaerythritol Tetrakis(3-(3,5-di-tert-butyl-4-hydroxyphenyl)propionate)). IRGAFOS™ 168 is a hydrolytically stable phosphite processing stabilizer (Tris(2,4-ditert-butylphenyl)phosphite). IRGANOX™ 1330 is 1,3,5-trimethyl-2,4,6-tris(3,5-di-tert-butyl-4-hydroxybenzyl)benzene. IRGANOX™ 1024 is 3-(3,5-ditert-butyl-4-hydroxyphenyl)-NT-[3-(3,5-ditert-butyl-4-hydroxyphenyl)propanoyl]propanehydrazide. KETTLITZ™ TAIC liquid contains triallylisocyanurate (TAIC). In some aspects, the TAIC may be bound in an EPM binder for easier handling.

TABLE 3

| | Relative | First | Second |
|---|---|---|---|
| | Amount | range | range |
| Component | (wt %) | (wt %) | (wt %) |
| ENGAGE 8150 | 29.34 | 10-50 | 25-35 |
| INFUSE 9107 | 68.46 | 55-85 | 65-75 |
| CHIMASSORB 2020 FDL | 0.20 | 0-1 | 0.1-0.5 |
| IRGANOX 1010 | 0.10 | 0-1 | 0.05-0.2 |
| IRGAFOS 168 | 0.05 | 0-0.5 | 0.02-0.1 |
| Kettlitz TAIC liquid | 1.40 | 0.5-2.5 | 1-2 |
| IRGANOX 1330 | 0.20 | 0-0.5 | 0.1-0.3 |
| IRGANOX MD 1024 | 0.25 | 0-1 | 0.2-0.3 |
| Total | 100 | 100 | 100 |

### Example 3

Example 3 or ED116-4E was produced by extruding 27.4 wt % of silane-crosslinkable polyolefin elastomer of Example 2, 65.0 wt % EPDM blend, 0.3 wt % ETHANOX™ 4703, 3.0 wt %, PERKADOX™ 14-40K PD, 2.0 wt % STRUKTOL™ WB 16, and 2.3 wt % CaO together to form the silane-grafted polyolefin elastomer. The Example 3 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 3 silane-crosslinkable polyolefin elastomer was then cured at ambient temperature and humidity to form the corresponding silane-crosslinked polyolefin elastomer. The composition of Example 3 and acceptable composition ranges for the various components are provided in Table 4 below.

TABLE 4

| | Relative | First | Second |
|---|---|---|---|
| | Amount | range | range |
| Component | (wt %) | (wt %) | (wt %) |
| ED116 (from Example 2) | 27.4 | 15-40 | 25-30 |
| EPDM blend | 65.0 | 50-80 | 60-70 |
| ETHANOX 4703 | 0.3 | 0-1 | 0.1-0.5 |
| Perkadox 14-40K PD | 3.0 | 0-5 | 2-4 |
| STRUKTOL WB 16 | 2 | 0-5 | 1-3 |
| CaO | 2.3 | 0-5 | 1.5-3 |
| Total | 100 | 100 | 100 |

### Comparative Example 1

Comparative Example 1 or EPDM Blend was produced by extruding 60.00 phr KELTAN™ 6160D, 40.00 phr DUTRAL™ CO 054, 86.20 phr Spheron 5000 A-silo 9, 19.00 phr PANSIL™, 55.00 phr TUDALEN™ 16, 5.00 phr STRUKTO™L WB 16, 0.50 phr RESIMENE™ 3520 S-65, 1.70 phr LUVOMAXX™ TMQ, 1.70 phr ACTIGRAN SO 70, 2.60 phr ZnO Silox Active, 5.20 phr RHENOFIT™ D/A. and 5.20 phr SANTOWEB™ H together to form a polyolefin elastomer. The Comparative Example 1 polyolefin elastomer was then extruded with 300 ppm to 400 ppm dioctyltin dilaurate (DOTL) condensation catalyst to form a cured polyolefin elastomer. The composition of Comparative Example 1 is provided in Table 5 below.

TABLE 5

| | PHR |
|---|---|
| | (parts per hundred |
| Component | resin/rubber) |
| KELTAN 6160D | 60.00 |
| DUTRAL CO 054 | 40.00 |
| Spheron 5000 A-silo 9 | 86.20 |
| PANSIL | 19.00 |
| TUDALEN 16 | 55.00 |
| STRUKTOL WB 16 | 5.00 |
| RESIMENE 3520 S-65 | 0.50 |
| LUVOMAXX TMQ | 1.70 |
| ACTIGRAN SO 70 | 1.70 |
| ZnO Silox Active | 2.60 |
| RHENOFIT D/A | 5.20 |
| SANTOWEB H | 5.20 |

With further regard to Example 3 and Comparative Example 1, ETHANOX™ 4703 is a lubricant antioxidant having the chemical formula (I) below:

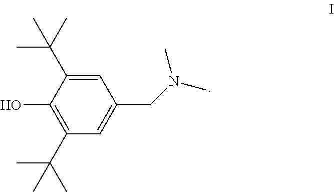 [SMILES: CN(C)Cc1cc(C(C)(C)C)c(O)c(C(C)(C)C)c1]

PERKADOX™ 14-40K PD is di(tert-butylperoxyisopropyl)benzene, powder 40% with clay and silica. STRUKTOL™ WB 16 is a mixture of fatty acid soaps, predominantly calcium. KELTAN™ 6160D is an EPDM terpolymer. DUTRAL™ CO 054 is an ethylene-propylene copolymer produced by suspension polymerization using a Ziegler-Natta catalyst. Spheron 5000 A-silo 9 is a carbon black. PANSIL™ is silica-alumina microspheres. The microspheres may contain from about 27 wt % to about 33 wt % alumina (as Al₂O₃), from about 55 wt % to about 65 wt % silica (as SiO₂), and a maximum of 4 wt % iron (as Fe₂O₃) while the pH of the microsphere is from about 8 to about 11. TUDALEN™ 16 is a paraffin oil which may function as a softener for EPDM. RESIMENE™ 3520 S-65 is hexamethoxymethyl-melamine resin, absorbed on a silica-based carrier. LUVOMAXX™ TMQ is an antioxidant composition containing polymeric 2,2,4-trimethyl-1,2-dihydro-quinoline. ACTIGRAN™ SO 70 is a scorch retarded trimethyloltrimethacrylate with an activity of 70% on an inert carrier in granular form. ZnO silox active is a high-performance active zinc oxide. RHENOFIT™ D/A is a highly-reactive magnesium oxide which is a vulcanization activator and an acid acceptor. SANTOWEB™ H is a treated cellulose fiber product.

### Example 4

Example 4 or ED116-4E was produced by extruding 26.65 wt % of silane-crosslinkable polyolefin elastomer of Example 2, 64.25 wt % EPDM blend, 0.3 wt % ETHANOX™ 4703, 4.5 wt % PERKADOX™ 14-40K PD, 2 wt % STRUKTOL™ WB 16, and 2.3 wt % CaO together to form the silane-grafted polyolefin elastomer. The Example 4 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 4 silane-crosslinkable polyolefin elastomer was then cured at ambient temperature and humidity to form corresponding silane-crosslinked polyolefin elastomer. The composition of Example 4 and acceptable composition ranges for the various components of this example are provided in Table 6 below.

TABLE 6

| | Relative | First | Second |
|---|---|---|---|
| | amount | range | range |
| Component | (wt %) | (wt %) | (wt %) |
| ED116 (from Example 2) | 26.65 | 10-40 | 20-30 |
| EPDM blend | 64.25 | 50-80 | 60-70 |
| ETHANOX 4703 | 0.3 | 0-2 | 0.1-1 |
| Perkadox 14-40K PD | 4.5 | 1-10 | 4-5 |
| Struktol WB 16 | 2 | 0-5 | 1-3 |
| CaO | 2.3 | 0-5 | 1.5-3 |
| Total | 100 | 100 | 100 |

### Example 5

Example 5 or ED116-4G was produced by extruding 26.21 wt % of silane-crosslinkable polyolefin elastomer of Example 2, 63.19 wt % EPDM blend, 0.3 wt % ETHANOX™ 4703, 6.0 wt % PERKADOX™ 14-40K PD, 2 wt % STRUKTOL™ WB 16, and 2.3 wt % CaO together to form the silane-grafted polyolefin elastomer. The Example 5 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 5 silane-crosslinkable polyolefin elastomer was then cured at ambient temperature and humidity to form the corresponding silane-crosslinked polyolefin elastomer. The composition of Example 5 and acceptable composition ranges for the various components of this example are provided in Table 7 below.

TABLE 7

| | Relative | First | Second |
|---|---|---|---|
| | amount | range | range |
| Component | (wt %) | (wt %) | (wt %) |
| ED116 (from Example 2) | 26.21 | 10-40 | 20-30 |
| EPDM blend | 63.19 | 50-80 | 60-70 |
| ETHANOX 4703 | 0.3 | 0-5 | 0.1-0.5 |
| Perkadox 14-40K PD | 6.0 | 0-10 | 4-8 |
| STRUKTOL WB 16 | 2 | 0-5 | 1-3 |
| CaO | 2.3 | 0-5 | 1.5-3 |
| Total | 100 | 100 | 100 |

### Example 6

Example 6 or ED108-2A was produced by extruding 48.70 wt % ENGAGE™ 8842, 2.60 wt % RHS 14/032, and 48.70 wt % XUS 38677.15 together to form the silane-grafted polyolefin elastomer. The Example 6 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 6 silane-crosslinkable polyolefin elastomer was then cured at ambient temperature and humidity to form the corresponding silane-crosslinked polyolefin elastomer. The composition of Example 6 and acceptable composition ranges for the various components of this example are provided in Table 8 below.

TABLE 8

| | Relative | First | Second |
|---|---|---|---|
| | amount | range | range |
| Component | (wt %) | (wt %) | (wt %) |
| ENGAGE 8842 | 48.70 | 40-60 | 45-55 |
| RHS 14/032 | 2.60 | 1-5 | 2-3 |
| XUS 38677.15 | 48.70 | 40-60 | 45-55 |
| Total | 100 | 100 | 100 |

### Example 7

Example 7 or ED108/EPDM was produced by extruding 47.5 wt % silane-crosslinkable polyolefin elastomer of Example 6, 47.5 wt % EPDM blend, 4.0 wt % LUPEROX™ F40MSP, and 1.0 wt % DOTL together to form the silane-grafted polyolefin elastomer. LUPEROX™ F40MSP is 1,3(4)-bis(tert-butylperoxyisopropyl)benzene. The Example 7 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 7 silane-crosslinkable polyolefin elastomer was then cured at ambient temperature and humidity to form the corresponding silane-crosslinked polyolefin elastomer. The composition of Example 7 and acceptable composition ranges for the various components of this example are provided in Table 9 below.

TABLE 9

| | Relative | First | Second |
|---|---|---|---|
| | amount | range | range |
| Component | (wt %) | (wt %) | (wt %) |
| ED108-2A (from Example 6) | 47.5 | 35-60 | 45-50 |
| EPDM blend | 47.5 | 35-60 | 45-50 |
| Luperox F4OMSP | 4 | 0-10 | 2-6 |
| DOTL | 1 | 0-5 | 0.5-2 |
| Total | 100 | 100 | 100 |

### Example 8

Example 8 or 486-882-17 was produced by extruding 16.11 wt % silane-crosslinkable polyolefin elastomer of Example 2, 38.02 wt % VN878P, 4.02 wt % TAMFER™ DF810, 15.25 wt % N-234 carbon black, 1.46 wt % Silica, 8.0 wt % Pyrograf III Nanofibers, 1.89 wt % CaO, 0.95 wt % STRUKTOL WB16, 6.65 wt % Parafinnic oil, 2.92 wt % SEG 15/0714, 0.28 wt % VULCOFAC™ TAIC-70, 4.12 wt % Vulcup 40KE, and 0.3 wt % Vanox ZMTI together to form the silane-grafted polyolefin elastomer. The Example 8 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 8 silane-crosslinkable polyolefin elastomer was then cured at ambient temperature and humidity to form the corresponding silane-crosslinked polyolefin elastomer. The composition of Example 8 and acceptable composition ranges for the various components of this example are provided in Table 10 below.

VN 878P is an EPM block copolymer. TAMFER™ DF810 is an ethylene-based polymer designed to improve impact resistance, flexibility, and softness of polyolefins. N-234 carbon black is a high-performance carbon black. Pyrograf III nanofibers are stacked-cup carbon nanotubes. SEG 15/0714 is an antioxidant blend. VULCOFAC™ TAIC-70 contains the active ingredient triallyl isocyanurate. VulCup 40KE is an organic peroxide. Vanox ZMTI is an antioxidant.

TABLE 10

| | Relative | First | Second |
|---|---|---|---|
| | amount | range | range |
| Component | (wt %) | (wt %) | (wt %) |
| ED116 (from Example 2) | 16.11 | 10-20 | 15-18 |
| VN878P | 38.02 | 25-55 | 35-42 |
| Tafmer DF810 | 4.02 | 1-10 | 3-5 |
| N-234 carbon black | 15.25 | 5-25 | 10-20 |
| Silica | 1.46 | 0-10 | 0.5-2 |
| Pyrograf III Nanofibers | 8.0 | 0-15 | 5-10 |
| CaO | 1.89 | 0-5 | 1-2.5 |
| STRUKTOL WB16 | 0.95 | 0-3 | 0.5-1.5 |
| Paraffinic oil | 6.65 | 0-10 | 5-8 |
| SEG 15/0714 | 2.92 | 0-5 | 2-4 |
| VULCOFAC TAIC-70 | 0.28 | 0-3 | 0.1-0.5 |
| VulCup 40KE | 4.12 | 0-10 | 3-6 |
| Vanox ZMTI | 0.3 | 0-2 | 0.1-0.5 |
| Total | 100 | 100 | 100 |

### Example 9

Example 9 or ED76-5 was produced by extruding 19.00 wt % ENGAGE™ 8150, 53.00 wt % ENGAGE 8842, 25.00 wt % MOSTEN™ TB 003 together with 3.0 wt % SILAN RHS14/032 or SILFIN 29 to form the silane-grafted polyolefin elastomer. The Example 9 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 9 silane-crosslinkable polyolefin elastomer was then cured at ambient temperature and humidity to form the corresponding silane-crosslinked polyolefin elastomer. The composition of Example 9 and acceptable composition ranges for the various components of this example are provided in Table 11 below.

TABLE 11

| | Relative | First | Second |
|---|---|---|---|
| | amount | range | range |
| Component | (wt %) | (wt %) | (wt %) |
| ENGAGE 8150 | 19.00 | 5-30 | 15-25 |
| ENGAGE 8842 | 53.00 | 40-70 | 45-60 |
| MOSTEN TB 003 | 25.00 | 10-40 | 20-30 |
| SILAN RHS 14/032 | 3.00 | 1-5 | 2-4 |
| Total | 100 | 100 | 100 |

### Example 10

Example 10 or ED76-6 was produced by extruding 45.64 wt % ENGAGE™ 8842, 16.36 wt % ENGAGE™ 8150, 35.00 wt % MOSTEN™ TB 003 together with 3.0 wt % SILAN RHS14/032 or SILFIN 29 to form the silane-grafted polyolefin elastomer. The Example 10 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 10 silane-crosslinkable polyolefin elastomer was then cured at ambient temperature and humidity to form the corresponding silane-crosslinked polyolefin elastomer. The composition of Example 10 and acceptable composition ranges for the various components of this example are provided in Table 12 below.

TABLE 12

| | Relative | First | Second |
|---|---|---|---|
| | amount | range | range |
| Component | (wt %) | (wt %) | (wt %) |
| ENGAGE 8842 | 45.64 | 30-60 | 40-50 |
| ENGAGE 8150 | 16.36 | 5-25 | 10-20 |
| RHS 14/032 | 3.00 | 1-5 | 2-4 |
| MOSTEN TB 003 | 35.00 | 15-55 | 30-40 |
| Total | 100 | 100 | 100 |

### Example 11

Example 11 or ED76-4A was produced by extruding 82.55 wt % ENGAGE™ 8842, 14.45 wt % MOSTEN™ TB 003 together with 3.0 wt % SILAN RHS14/032 or SILFIN 29 to form the silane-grafted polyolefin elastomer. The Example 11 silane-grafted polyolefin elastomer was then extruded with 300 ppm to 400 ppm dioctyltin dilaurate (DOTL) condensation catalyst to form a silane-crosslinkable polyolefin elastomer that can be molded or extruded into an uncured hose element. The Example 11 silane-crosslinkable polyolefin elastomer was then cured at ambient temperature and humidity to form the corresponding silane-crosslinked polyolefin elastomer. The composition of Example 11 and acceptable composition ranges for the various components of this example are provided in Table 13 below.

TABLE 13

| | Relative | First | Second |
|---|---|---|---|
| | amount | range | range |
| Component | (wt %) | (wt %) | (wt %) |
| ENGAGE 8842 | 82.55 | 60-90 | 75-85 |
| RHS 14/032 | 3.00 | 1-5 | 2-4 |
| MOSTEN TB 003 | 14.45 | 5-25 | 10-20 |
| Total | 100 | 100 | 100 |

Abrasion testing results were performed for Examples 1, 2, 6, and 11 using a William's Abrasion Testing method (JIS K6242). The test conditions included a rotation speed of 37±3 rpm, a load of 35.5N, and a testing time of 6 minutes. Comparative data was provided for a bicycle tire and a shoe sole. The results are provided below in Table 14.

TABLE 14

| | | | | | | | Abrasion | |
|---|---|---|---|---|---|---|---|---|
| | | | | | | | volume | |
| | SG | | mass decrease(g) | | | | [symbol] V | [symbol] V1000 |
| Material | (g/cm³) | | 1 | 2 | 3 | Ave. | (mm³) | (mm³) |
| Ex. 11 | 0.880 | \textcircled{1} | 0.0036 | 0.0062 | 0.0045 | 0.0044 | 5.0 | 21.8 |
| | | \textcircled{2} | 0.0029 | 0.0033 | 0.0057 | | | |
| Ex. 1 | 0.911 | \textcircled{1} | 0.0450 | 0.0424 | 0.0271 | 0.0296 | 32.5 | 142.3 |
| | | \textcircled{2} | 0.0246 | 0.0210 | 0.0173 | | | |
| Ex. 6 | 0.962 | \textcircled{1} | 0.0533 | 0.0465 | 0.0478 | 0.0446 | 46.4 | 203.4 |
| | | \textcircled{2} | 0.0410 | 0.0410 | 0.0381 | | | |
| Ex. 2 | 1.080 | \textcircled{1} | 0.2513 | 0.2675 | 0.2468 | 0.2374 | 219.8 | 964.2 |
| | | \textcircled{2} | 0.2201 | 0.2371 | 0.2017 | | | |
| Bicycle Tire | 1.281 | \textcircled{1} | 0.4897 | 0.6030 | 0.5502 | 0.4513 | 352.28 | 1545.1 |
| | | \textcircled{2} | 0.3192 | 0.3504 | 0.3951 | | | |
| Shoe Sole | 1.136 | \textcircled{1} | 0.0849 | 0.0849 | 0.0851 | 0.0779 | 68.56 | 300.7 |
| | | \textcircled{2} | 0.0667 | 0.0637 | 0.0820 | | | |

For purposes of this disclosure, the term “coupled” (in all of its forms, couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the articles, processes and compositions, which are defined by the following claims as interpreted according to the principles of patent law, including the Doctrine of Equivalents.

### Listing of Non-Limiting Embodiments

Embodiment A is a hose comprising: a composition comprising a silane-crosslinked polyolefin elastomer and a filler; wherein the composition exhibits a compression set of from about 5% to about 35%, as measured according to ASTM D 395 Method B (168 hrs at 150° C.); and wherein the composition has a density from about 0.88 g/cm³ to about 1.05 g/cm³.

The hose of Embodiment A wherein the compression set is from about 10% to about 30%.

The hose of Embodiment A or Embodiment A with any of the intervening features wherein the silane-crosslinked polyolefin elastomer exhibits a crystallinity of from about 5% to about 25%.

The hose of Embodiment A or Embodiment A with any of the intervening features wherein the silane-crosslinked polyolefin elastomer has a glass transition temperature of from about −75° C. to about −25° C.

The hose of Embodiment A or Embodiment A with any of the intervening features wherein the silane-crosslinked polyolefin elastomer comprises a first polyolefin having a density less than 0.86 g/cm³, a second polyolefin, a silane crosslinker, a radical initiator, and a non-metal condensation catalyst.

The hose of Embodiment A or Embodiment A with any of the intervening features wherein the density of the composition is from about 0.92 g/cm³ to about 1.0 g/cm³.

The hose of Embodiment A or Embodiment A with any of the intervening features wherein the density of the composition is from about 0.95 g/cm³ to about 0.98 g/cm³.

The hose of Embodiment A or Embodiment A with any of the intervening features wherein the composition exhibits thermoplastic properties during processing and thermoset properties after the composition is cured.

Embodiment B is a hose for transferring coolant liquid in a motor of a vehicle, the hose comprising: a first layer of a first silane-crosslinked polyolefin elastomer; a second layer of a second silane-crosslinked polyolefin elastomer; and a textile reinforcement embedded between the first and second layers of the silane-crosslinked polyolefin elastomers.

The hose of Embodiment B wherein the textile reinforcement is made by knitting, spiraling, braiding, or a combination thereof.

The hose of Embodiment B or Embodiment B with any of the intervening features wherein the textile reinforcement is a yarn comprising a polyamide, a polyester, a polyaramid, or a combination thereof.

The hose of Embodiment B or Embodiment B with any of the intervening features wherein the hose has a wall thickness of from about 1 millimeter to about 4 millimeters.

The hose of Embodiment B or Embodiment B with any of the intervening features wherein the hose has a wall thickness of from about 1.5 millimeter to about 2.5 millimeters.

The hose of Embodiment B or Embodiment B with any of the intervening features wherein the first silane-crosslinked polyolefin elastomer and the second silane-crosslinked polyolefin elastomer are chemically distinct from each other.

The hose of Embodiment B or Embodiment B with any of the intervening features wherein the first silane-crosslinked polyolefin elastomer and the second silane-crosslinked polyolefin elastomer have a melting temperature greater than 150° C.

Embodiment C is a method for making a hose, the method comprising: extruding a first polyolefin having a density less than 0.86 g/cm³, a second polyolefin, a silane crosslinker, a radical initiator, and a condensation catalyst together to form an extruded crosslinkable polyolefin blend; cooling the extruded crosslinkable polyolefin blend; forming the extruded crosslinkable polyolefin blend into a hose element; and crosslinking the blend of the hose element to form the hose, wherein the hose exhibits a compression set of from about 5% to about 35%, as measured according to ASTM D 395 Method B (168 hrs at 150° C.), and wherein the hose has a density from about 0.88 g/cm³ to about 1.05 g/cm³.

The method of Embodiment C wherein the extruding step has a temperature from about 75° C. to about 120° C.

The method of Embodiment C or Embodiment C with any of the intervening features further comprising: adding a trimming, an overmolding, a reducer, a clamp, an alignment marker, a protective sleeve, or a combination thereof to the hose.

The method of Embodiment C or Embodiment C with any of the intervening features wherein the hose exhibits a crystallinity of from about 5% to about 25%.

The method of Embodiment C or Embodiment C with any of the intervening features wherein the hose has a glass transition temperature of from about −75° C. to about −25° C.

What is claimed is:

1. A hose comprising:
a composition comprising a silane-crosslinked polyolefin elastomer and a filler;
wherein the composition exhibits a compression set of from about 5% to about 35%, as measured according to ASTM D 395 Method B (168 hrs at 150° C.); and
wherein the composition has a density from about 0.88 g/cm³ to about 1.05 g/cm³.

2. The hose of claim 1, wherein the compression set is from about 10% to about 30%.

3. The hose of claim 1, wherein the silane-crosslinked polyolefin elastomer exhibits a crystallinity of from about 5% to about 25%.

4. The hose of claim 1, wherein the silane-crosslinked polyolefin elastomer has a glass transition temperature of from about −75° C. to about −25° C.

5. The hose of claim 1, wherein the silane-crosslinked polyolefin elastomer comprises a first polyolefin having a density less than 0.86 g/cm³, a second polyolefin, a silane crosslinker, a radical initiator, and a non-metal condensation catalyst.

6. The hose of claim 1, wherein the density of the composition is from about 0.92 g/cm³ to about 1.0 g/cm³.

7. The hose of claim 1, wherein the density of the composition is from about 0.95 g/cm³ to about 0.98 g/cm³.

8. The hose of claim 1, wherein the composition exhibits thermoplastic properties during processing and thermoset properties after the composition is cured.

9. A hose for transferring coolant liquid in a motor of a vehicle, the hose comprising:
a first layer of a first silane-crosslinked polyolefin elastomer;
a second layer of a second silane-crosslinked polyolefin elastomer; and
a textile reinforcement embedded between the first and second layers of the silane-crosslinked polyolefin elastomers.

10. The hose of claim 9, wherein the textile reinforcement is made by knitting, spiraling, braiding, or a combination thereof.

11. The hose of claim 9, wherein the textile reinforcement is a yarn comprising a polyamide, a polyester, a polyaramid, or a combination thereof.

12. The hose of claim 9, wherein the hose has a wall thickness of from about 1 millimeter to about 4 millimeters.

13. The hose of claim 9, wherein the hose has a wall thickness of from about 1.5 millimeter to about 2.5 millimeters.

14. The hose of claim 9, wherein the first silane-crosslinked polyolefin elastomer and the second silane-crosslinked polyolefin elastomer are chemically distinct from each other.

15. The hose of claim 9, wherein the first silane-crosslinked polyolefin elastomer and the second silane-crosslinked polyolefin elastomer have a melting temperature greater than 150° C.

16. A method for making a hose, the method comprising:
extruding a first polyolefin having a density less than 0.86 g/cm³, a second polyolefin, a silane crosslinker, a radical initiator, and a condensation catalyst together to form an extruded crosslinkable polyolefin blend;
cooling the extruded crosslinkable polyolefin blend;
forming the extruded crosslinkable polyolefin blend into a hose element; and
crosslinking the blend of the hose element to form the hose,
wherein the hose exhibits a compression set of from about 5% to about 35%, as measured according to ASTM D 395 Method B (168 hrs at 150° C.), and
wherein the hose has a density from about 0.88 g/cm³ to about 1.05 g/cm³.

17. The method of claim 16, wherein the extruding step has a temperature from about 75° C. to about 120° C.

18. The method of claim 16, further comprising:
adding a trimming, an overmolding, a reducer, a clamp, an alignment marker, a protective sleeve, or a combination thereof to the hose.

19. The method of claim 16, wherein the hose exhibits a crystallinity of from about 5% to about 25%.

20. The method of claim 16, wherein the hose has a glass transition temperature of from about −75° C. to about −25° C.
